(19) United States
(12) Patent Application Publication
(10) Pub. No.: US 2026/0236599 A1
(43) Pub. Date: Aug. 13, 2026

(54) UNIFIED PLATFORM FOR DEPLOYING AND OPERATING AI AGENTS ACROSS DISTRIBUTED ENVIRONMENTS

(71) Applicant: Anil Chandrupatla, San Jose, CA (US)

(72) Inventor: Anil Chandrupatla, San Jose, CA (US)

(21) Appl. No.: 19/454,155

(22) Filed: Jan. 20, 2026

Related U.S. Application Data
(60) Provisional application No. 63/756,494, filed on Feb. 10, 2025.

(51) Int. Cl. G06F 21/62

(52) U.S. Cl. CPC G06F 21/6218; G06F 2221/2141

(57) ABSTRACT

A system includes a central management location configured to coordinate AI deployments, a plurality of edge locations connected to the central management location where each edge location hosts AI agents, a distributed data fabric spanning the central management location and edge locations providing location-agnostic data access for the AI agents, and an orchestrator configured to manage deployment and operation of the AI agents based on business requirements associated with the edge locations. The distributed data fabric comprises a plurality of trust zones, each containing one or more data nodes. Each data node comprises a data access gateway configured to authorize data access requests from the μl agents. The orchestrator generates a safe context for each AI agent based on user scope and regulatory requirements, the safe context defining boundaries within which the AI agent is authorized to operate.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

Trademarks used in the disclosure of the invention, and the applicants, make no claim to any trademarks referenced.

### CROSS-REFERENCE TO RELATED APPLICATIONS

This application claims the benefit of U.S. Provisional Patent Application No. 63/756,494, filed on Feb. 10, 2025, which is incorporated by reference herein in its entirety.

### BACKGROUND OF THE INVENTION

### 1) Field of the Invention

The invention relates in general to the field of deployment of artificial intelligence capabilities across multiple deployment environments, and more particularly to a unified system and method for seamless deployment, management, and operation of AI agents and applications across diverse computing environments including edge locations, data centers, and cloud infrastructures.

### 2) Description of Related Art

Currently the state of the art for the deployment and management of artificial intelligence (AI) systems is complex and for the technology to grow in use there needs to be improvements which make the deployment and management of these system simpler.

Due to the face that the deployment and management of artificial intelligence (AI) systems have become increasingly complex as data generation and processing requirements evolve. This results in traditional centralized computing models being inadequate for handling the diverse needs of modern enterprises, which require AI processing capabilities across a spectrum of environments, from edge locations to data centers and cloud infrastructures.

As data generation at edge locations continues to grow, organizations face challenges in deploying AI solutions close to these data sources. This proximity is often desirable for real-time processing, reduced latency, and compliance with data sovereignty regulations. However, managing AI infrastructure across distributed environments introduces complexities in hardware provisioning, software deployment, data pipeline management, and ongoing maintenance.

The movement of AI workloads to more secure, enterprise-controlled environments such as on-premises data centers or virtual private clouds presents additional logistical hurdles. Organizations may navigate the intricacies of integrating AI systems across diverse infrastructural landscapes while attempting to maintain consistent performance, security, and compliance.

Enterprises often desire granular control over data access, processing locations, and AI agent interactions to maintain regulatory compliance and protect sensitive information. The optimization of hardware resource utilization for AI workloads is another area of concern for organizations seeking to balance performance with cost-effectiveness and sustainability. Efficient allocation and management of computing resources across distributed environments may be challenging, particularly when dealing with heterogeneous hardware configurations.

As the AI landscape continues to evolve, there is a growing interest in solutions that can address these challenges. Improvements in this field could potentially democratize access to advanced AI technologies, making them more accessible to a broader range of enterprises regardless of their technical expertise or infrastructure constraints. This could, in turn, accelerate innovation and drive the adoption of AI-powered solutions across various industries and use cases.

The system can further be described as a system for deploying and managing AI agents across distributed environments which may include a central management location connected to a plurality of edge locations via a distributed data fabric, and an orchestrator. The central management location may be configured to coordinate AI deployments. The edge locations connected to the central management location may each be configured to host AI agents. The distributed data fabric may span the central management location and the edge locations and provide location-agnostic data access for the AI agents. The orchestrator may be configured to manage deployment and operation of the AI agents based on business requirements associated with the edge locations.

The distributed data fabric may comprise multiple trust zones, each trust zone containing one or more data nodes. Each data node may comprise a data access gateway configured to authorize data access requests from AI agents. The data access gateway may utilize Access Control List (ACL) statements to manage and restrict data access.

The orchestrator may be configured to generate a safe context for each AI agent based on user scope and regulatory requirements. The safe context may define boundaries within which the AI agent is authorized to operate. The orchestrator may dynamically adjust resource allocation for AI agents based on the safe context and real-time performance data.

A method for deploying and managing AI agents across distributed environments may comprise the steps of receiving a request to deploy an AI agent, determining a deployment location from a plurality of available locations including edge locations and cloud environments, generating a deployment workflow for the AI agent based on the determined deployment location, validating the deployment workflow, and subject to such validation, executing the validated deployment workflow to deploy the AI agent at the determined deployment location.

The method may further include the steps of generating a safe context for the AI agent based on user scope and regulatory requirements and configuring the AI agent to operate within boundaries defined by the safe context. The safe context may include permissions for accessing specific datasets within a distributed data fabric. The distributed data fabric may span multiple trust zones, each trust zone containing one or more data nodes. The method may include the further steps of receiving a data access request from the deployed AI agent, routing the data access request through a data access gateway, and authorizing the data access request based on Access Control List (ACL) statements associated with the AI agent. The step of authorizing the data access request may include verifying that the requested data access falls within the boundaries defined by the safe context and granting access only if the verification is successful. The method may include the further steps of monitoring performance metrics of the deployed AI agent, dynamically adjusting resource allocation for the AI agent based on the monitored performance metrics and the safe context, and updating the deployment workflow based on the adjusted resource allocation.

A non-transitory computer-readable medium may store instructions that, when executed by a processor, cause the processor to perform operations for managing data access in a distributed AI environment, the operations including the steps of receiving a data access request from an AI agent, determining a safe context for the AI agent based on user scope and regulatory requirements, validating the data access request against access control rules within the determined safe context, and subject to validation, providing the AI agent with access to requested data through a distributed data fabric spanning multiple deployment locations.

The distributed data fabric may comprise multiple trust zones, each trust zone containing one or more data nodes. Each data node may comprise a data access gateway configured to authorize data access requests from AI agents. Validating the data access request may include verifying that the requested data access falls within boundaries defined by the safe context and granting access only if the verification is successful. The operations performed by the processor under instruction by the non-transitory computer-readable medium may further include monitoring performance metrics of the AI agent, and dynamically adjusting resource allocation for the AI agent based on the monitored performance metrics and the safe context. The operations may further include generating a deployment workflow for the AI agent based on a determined deployment location and updating the deployment workflow based on the adjusted resource allocation.

These and other objects, features, and advantages of the present invention will become more readily apparent from the attached drawings and the detailed description of the preferred embodiments, which follow.

### SUMMARY OF THE INVENTION

Bearing in mind the problems and deficiencies of the prior art, it is therefore an object of the present invention to provide a simpler system for the for the deployment and management of artificial intelligence (AI) systems.

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

According to an aspect of the present disclosure, a system is provided. The system includes a central management location configured to coordinate AI deployments. The system includes a plurality of edge locations connected to the central management location. Each edge location is configured to host AI agents. The system includes a distributed data fabric spanning the central management location and the edge locations. The distributed data fabric provides location-agnostic data access for the AI agents. The system includes an orchestrator configured to manage deployment and operation of the AI agents based on business requirements associated with the edge locations.

According to another aspect of the present disclosure, a method is provided. The method includes receiving a request to deploy an AI agent. The method includes determining a deployment location from a plurality of available locations including edge locations and cloud environments. The method includes generating a deployment workflow for the AI agent based on the determined deployment location. The method includes validating the deployment workflow. The method includes, subject to successful validation, executing the validated deployment workflow to deploy the AI agent at the determined deployment location.

The foregoing general description of the illustrative embodiments and the following detailed description thereof are merely exemplary aspects of the teachings of this disclosure and are not restrictive.

Still other objects and advantages of the invention will in part be obvious and will in part be apparent from the specification.

The above and other objects, which will be apparent to those skilled in the art, are achieved in the present invention, which is directed to a system, comprising:
a. a central management location configured to coordinate AI deployments;
b. a plurality of edge locations connected to the central management location, each edge location configured to host AI agents;
c. a distributed data fabric spanning the central management location and the edge locations, the distributed data fabric providing location-agnostic data access for the AI agents; and
d. an orchestrator configured to manage deployment and operation of the AI agents based on business requirements associated with the edge locations.

### BRIEF DESCRIPTION OF THE DRAWINGS

A further understanding of the nature and advantages of particular embodiments may be realized by reference to the remaining portions of the specification and the drawings, in which like reference numerals are used to refer to similar components. When reference is made to a reference numeral without specification to an existing sub-label, it is intended to refer to all such multiple similar components.

FIG. 1 illustrates a system diagram of a deployment system for deploying and operating AI agents across distributed environments, according to aspects of the present disclosure.

FIG. 2 is a schematic diagram of an AI agent platform configured to generate a safe context for AI LLM agents, according to an embodiment.

FIG. 3 illustrates a distributed data fabric architecture configured to enable data access across multiple deployment locations, according to aspects of the present disclosure.

FIG. 4 illustrates a system diagram of a distributed data access architecture, according to an embodiment.

FIG. 5 is a flowchart depicting a process for application deployment in the deployment system of FIG. 1, according to aspects of the present disclosure.

FIG. 6 depicts the system architecture, showing the cloud storage interface and cloud network.

FIG. 7 is a representation of is an illustration predictive, elastic orchestration.

FIG. 8 illustrates an implementation of a sequence diagram depicting the system in action

Corresponding reference characters indicate corresponding parts throughout the several views. The exemplifications set out herein illustrate embodiments of the invention and such exemplifications are not to be construed as limiting the scope of the invention in any manner.

### DETAILED DESCRIPTION

While various aspects and features of certain embodiments have been summarized above, the following detailed description illustrates a few exemplary embodiments in further detail to enable one skilled in the art to practice such embodiments. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art however that other embodiments of the present invention may be practiced without some of these specific details. Several embodiments are described herein, and while various features are ascribed to different embodiments, it should be appreciated that the features described with respect to one embodiment may be incorporated with other embodiments as well. By the same token however, no single feature or features of any described embodiment should be considered essential to every embodiment of the invention, as other embodiments of the invention may omit such features.

In this application the use of the singular includes the plural unless specifically stated otherwise and use of the terms “and” and “or” is equivalent to “and/or,” also referred to as “non-exclusive or” unless otherwise indicated. Moreover, the use of the term “including,” as well as other forms, such as “includes” and “included,” should be considered non-exclusive. Also, terms such as “element” or “component” encompass both elements and components including one unit and elements and components that include more than one unit, unless specifically stated otherwise.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps or acts are in some way inherently mutually exclusive.

As this invention is susceptible to embodiments of many different forms, it is intended that the present disclosure be considered as an example of the principles of the invention and not intended to limit the invention to the specific embodiments shown and described.

Prior to a discussion of the preferred embodiment of the invention, it should be understood that while the features and advantages of the invention are illustrated in terms of a system for the deployment and management of artificial intelligence (AI) systems the applicant envisions numerous alternative uses for the system currently disclosed and reserves all the rights to those applications. Also, as this invention is susceptible to embodiments of many different forms, it is intended that the present disclosure be considered as an example of the principles of the invention and not intended to limit the invention to the specific embodiments shown and described.

The following description sets forth exemplary aspects of the present disclosure. It should be recognized, however, that such description is not intended as a limitation on the scope of the present disclosure. Rather, the description also encompasses combinations and modifications to those exemplary aspects described herein.

The deployment and management of artificial intelligence (AI) systems has become increasingly complex as data generation and processing requirements have increased. Modern enterprises require AI processing capabilities across a spectrum of environments, from edge locations to data centers and cloud infrastructures.

As data generation at the edge locations continues to grow, organizations face challenges in deploying AI solutions close to these data sources to obtain the benefits of real-time processing, reduced latency, and compliance with data sovereignty regulations.

Movement of AI workloads to more secure, enterprise-controlled environments such as on-premises data centers or virtual private clouds (VPCs) presents additional logistical hurdles as organizations must navigate the intricacies of integrating AI systems across diverse infrastructural landscapes while ensuring consistent performance, security, and compliance.

Furthermore, enterprises often require granular control over data access, processing locations, and AI agent interactions to maintain regulatory compliance and protect sensitive information.

The optimization of hardware resource utilization for AI workloads is another area of concern for organizations seeking to balance performance with cost-effectiveness and sustainability. Efficient allocation and management of computing resources across distributed environments may be challenging, particularly when dealing with heterogeneous hardware configurations.

As the AI landscape continues to evolve, there is a growing need for a unified approach to AI deployment and management. Such a unified approach may enable seamless integration of AI capabilities across various operational environments while offering flexibility, scalability, and robust security measures. This could potentially democratize access to advanced AI technologies, making them more accessible to a broader range of enterprises regardless of their technical expertise or infrastructure constraints. This could, in turn, accelerate innovation and drive the adoption of AI-powered solutions across various industries and use cases.

To address these challenges, the present disclosure relates to a unified platform for deploying and operating AI agents and applications across distributed environments. This platform may enable seamless deployment of AI solutions across various locations, including edge environments, customer data centers, co-location facilities, disconnected data centers, and/or public cloud virtual private clouds (VPCs).

The platform may provide capabilities for efficient management and operation of AI agents and applications in diverse deployment scenarios. In some cases, the platform may reduce the need for specialized IT, machine learning, and AI talent typically required for such deployments. The system may also decrease costs associated with deploying and managing AI solutions across distributed environments.

Security and compliance may be enhanced through the platform's features, which may include access controls and data governance mechanisms. The platform may allow for flexible scalability across diverse deployments, potentially making advanced AI technologies more accessible to a broader range of enterprises.

According to an aspect of the present disclosure, a seamless platform is provided. The seamless platform is configured to deploy AI agents/applications across edge locations, customer data centers, co-location facilities, disconnected data centers, and public clouds.

According to another aspect of the present disclosure, a system for one-click move of AI agents/applications across deployments is provided. The system enables an AI agent deployed in a public cloud on the platform to be moved to run on an edge location on the platform with a single click or API call.

According to another aspect of the present disclosure, a system for one-time migration of AI solutions is provided. The system enables AI solution providers to migrate their current solution from existing public cloud providers to the platform, thereby enabling deployment of their solutions to a customer's data center and/or their VPC in their current cloud provider.

According to another aspect of the present disclosure, a system for enterprise control of data serving and access is provided. The system enables enterprises to control where their data is served and who can access the data.

According to another aspect of the present disclosure, a business SLA driven agent orchestrator is provided. The orchestration engine understands business requirements to be delivered by AI agents and exploits that to optimize infrastructure resource usage.

According to another aspect of the present disclosure, an access control system for agents is provided. The system controls which agents can communicate with other agents for security and compliance purposes.

According to another aspect of the present disclosure, a data control system for agents is provided. The system controls what agent has access to what data, tracks historical data usage, and provides an easy way to grant or revoke access.

According to another aspect of the present disclosure, a system for suggesting and implementing business workflows is provided. The system has the ability to suggest workflows for business problems, which include IoT devices, Mobile Apps, Video Cameras, Document Readers, etc., and the ability to correlate and tie back real data from those sources to the business workflow. The system also provides mechanisms for users to influence the workflow or add human intervention points in the middle of AI workflows.

According to another aspect of the present disclosure, a system for efficient operations using auto-generated monitoring profiles is provided. The system uses adaptive learning and adjusting of the monitoring profile for low noise operational engagement and reduced operational cost for application, platform, and infrastructure.

The system uses the concept of serverless computing—where resources are provisioned on-demand, auto-scaled, and billed per invocation with AI inference to handle the variable workloads of AI spokes. This shifts the model from fixed or semi-static GPU provisioning to ephemeral, function-as-a-service (FaaS) inference pods that spin up/down dynamically, minimizing idle costs while enabling bursty, low-latency responses.

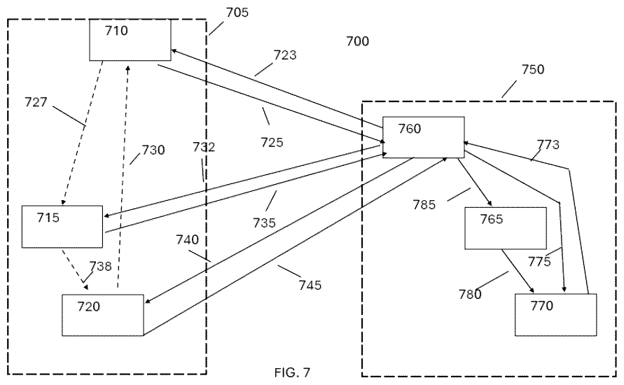

The novelty lies in predictive, elastic orchestration: The “Profile Generator” not only reacts to current KPIs (e.g., request rates) but proactively forecasts demand using lightweight ML models (e.g., LSTM-based predictors), prefetching model weights or adapters to slash cold-start latencies by 2-4×. This creates a “zero-warmup” inference fabric, where spokes become stateless serverless functions backed by heterogeneous GPUs (e.g., via mesh networks for decentralized edge compute). Add in elastic sharing-dynamically pooling underutilized GPU shards across spokes- and you get a system resilient to fragmentation, reducing waste. FIG. 7 illustrates the concept of in predictive, elastic orchestration.

Process 700 is comprised of two process 705 Serverless AI Inference and 750 AI Hub (centralized). Within the process 705 is process 710 Serverless Spoke 1 comprising:
a. On demand Invocation
b. Auto Scale GPUs (0-N)
c. Ephemeral Weights Cache

Process 710 passes GPU shard sharing 727 to process 715 Serverless Spoke 2 comprising:
a. On Demand Invocation
b. Auto-Scale GPUs (0-N)
c. Ephemeral Weights Cache

Process 715 passes GPU shard sharing 738 to process 720 Serverless Spoke N comprising:
a. On Demand Invocation.
b. Auto-Scale GPUs (0-N).
c. Ephemeral Weights Cache.

Process 720 Serverless Spoke N passes GPU shard sharing 730 back to process 710.

Process 710 Serverless Spoke 1 sends KPIs and Events 725 to process 760 Profile generator which comprises:
a. Synchronizing KPIs.
b. Predictive Forecasting (LSTM).
c. Compute Serverless form factor

Process 760 Profile generator sends Trigger Invocation and apply form factor 723 to Process 710 Serverless Spoke 1.

Process 715 Serverless Spoke 2 passes KPIs and Events 735 to process 760 Profile generator and process 760 Profile generator returns Trigger Invocation and apply form factor 732 back to Process 715 Serverless Spoke 2.

Process 720 Serverless Spoke N passes KPIs and Events 745 to process 760 Profile generator and process 760 Profile generator returns Trigger Invocation and apply form factor 740.

Process 760 Profile generator transfers data 785 to Process 765 Forcaster Module comprising:
a. Demand prediction
b. Prefetch
c. Adapter/Weights

Process 765 Forcaster passes forecasts 780 to process 770 Optimization engine. Process 760 Profile generator transfers data 775 to process 770 Optimization engine.

Process 770 Optimization engine comprises:
a. Cost mode (pay-per-token).
b. Performance mode (Zero-Warmup)
c. Balance Mode (Elastic Mesh)
d. Privacy-Balance mode

Process 770 Optimization engine passes Serverless decision (e.g., Invoke 2 GPUs, Prefetch LoRA, Token Throughput: 200 per second, Mode: Elastic Mesh) 773 to Process 760 Profile generator.

In the context of the serverless AI inferencing platform, KPI events represent structured telemetry data emitted periodically (e.g., every 15-60 seconds) or event-driven (e.g., on load spikes) from AI Spokes to the centralized Profile Generator in the Hub. These events aggregate key performance indicators (KPIs) to enable real-time monitoring, predictive forecasting (e.g., via LSTM), and dynamic form-factor optimization (e.g., scaling active GPUs or prefetching weights).

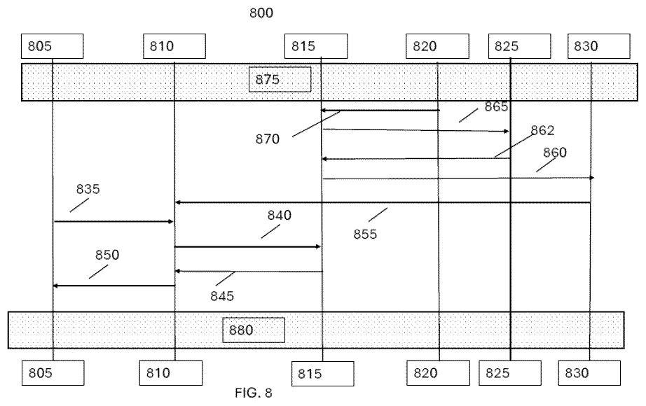

FIG. 8 illustrates an implementation of a sequence diagram depicting the system in action 800.

The predictive and reactive loop 875 and Loop: approximately 15-60 second intervals or event-triggered 880. The client request 805 passes invoke interference (event driven) 835 to Serverless spoke (Ephemeral Function) 810. Serverless spoke (Ephemeral Function) 810 Return response (Low-Latency Tokens) 850 to client request 805,

Serverless spoke (Ephemeral Function) 810 Send real-time KPIs (latency, throughput) 840 to Profile Generator (Hub) 815 and Profile Generator (Hub) 815 apply dynamic scaling (e.g. Burst to 4 GPUs) 845 to Serverless spoke (Ephemeral Function) 810.

Profile Generator (Hub) 815 sends request serverless optimization 865 to Optimization engine (HUB) 825 and Optimization engine (HUB) 825 returns Form-Factor) e.g., Prefetch Weights, Reserve 1-3 GPU Shards) 862 to Profile Generator (Hub) 815.

Profile Generator (Hub) 815 sends Provision Elastic resources to GPU mesh Layer 830 and Provision Elastic resources to GPU mesh Layer 830 sends spin up function (Zero-Warmup) to Serverless spoke (Ephemeral Function) 855 to Serverless spoke (Ephemeral Function) 810.

Forcaster Module (Hub) 820 sends Forecast Demand (LSTM on KPIs) to Profile Generator (Hub) 815.

The KPI event structure is shown in Table 1:

TABLE 1

| Field | Type | Required? | Description |
|---|---|---|---|
| event_id | String (UUID) | Yes | Unique identifier for the event to ensure idempotency during processing. |
| timestamp | ISO 8601 String | Yes | UTC timestamp when the event was generated (for time-series alignment). |
| spoke_id | String | Yes | Identifier for the emitting AI Spoke (e.g., edge node or serverless pod). |
| version | String | Yes | Scheme version for deserialization (e.g. “1.0” for initial, “2.0” for serverless |
| | | | extensions). |
| window_start | ISO 8601 String | Yes | Start of the aggregation window (e.g., for 1-min rolling averages). |
| window_end | ISO 8601 String | Yes | End of the aggregation window. |
| request_rate | Number (float) | Yes | Average requests per second (RPS) in the window; critical for load |
| | | | forecasting. |
| latency_p50 | Number (ms, float) | Yes | 50th percentile latency (median) for inference responses. |
| latency_p95 | Number (ms, float) | Yes | 95th percentile latency (for tail latency monitoring). |
| gpu_utilization | Number (%, float) | Yes | Average GPU utilization across active shards (0-100%). |
| active_gpus | Integer | Yes | Number of currently active GPUs in the spoke (post-form-factor application). |
| token_throughput | Number (tokens/ | Yes | Tokens processed per second; ties to form-factor mode (e.g., balanced vs. |
| | sec, float) | | high-perf). |
| error_rate | Number (%, float) | Yes | Percentage of failed requests (e.g., timeouts, OOM errors). |
| energy_consumption | Number (kWh, float) | No | Optional: Cumulative energy used in the window (for cost-optimized modes). |
| queue_depth | Integer | No | Current pending requests in the queue (for burst detection). |
| custom_metrics | Object (map<string, | No | Extensible key-value pairs (e.g., {“model_load_time”: 2.1, “prefetch_hit_rate”: |
| | any>) | | 0.85)). |
| raw_samples | Array<Object> | No | Optional array of granular samples for debugging (limit to 10-20 entries). |

The following description sets forth examples of aspects of the present disclosure. It should be recognized, however, that such description is not intended as a limitation on the scope of the present disclosure. Rather, the description also encompasses combinations and modifications to those examples described herein.

In some implementations, the platform may support one-click movement of AI agents and applications between different deployment environments. This capability may enable organizations to easily migrate their AI solutions from public clouds to on-premises infrastructure or between different edge locations as needed.

The platform may incorporate a distributed data fabric architecture, which may facilitate seamless data access and management across multiple trust zones and deployment locations. This architecture may enable AI agents and applications to operate effectively regardless of where data is physically stored or processed.

Business-driven orchestration of AI agents may be supported by the platform, potentially optimizing resource utilization while meeting specific business requirements. The system may also provide mechanisms for suggesting and implementing AI workflows tailored to particular business problems.

Efficient operations may be enabled through auto-generated monitoring profiles for applications, platform components, and infrastructure. These profiles may adapt over time, potentially reducing operational costs and minimizing false alerts.

By providing these capabilities in a unified platform, the disclosed system may address challenges associated with deploying and managing AI solutions across diverse and distributed environments. The platform may enable organizations to leverage AI technologies more effectively while maintaining control over their data and infrastructure.

The present disclosure relates to a unified platform for deploying and operating AI agents across distributed environments. The unified platform addresses challenges associated with deploying AI solutions across a spectrum of environments, from edge locations to data centers and cloud infrastructures. As data generation at edge locations continues to grow, organizations face challenges in deploying AI solutions close to data sources to obtain benefits of real-time processing, reduced latency, and compliance with data sovereignty regulations.

The unified platform employs an architecture that includes a central management location configured to coordinate AI deployments across a plurality of edge locations. The central management location functions as a hub in a hub-and-spoke architecture, where the central management location handles complex or resource-intensive tasks while the edge locations perform local processing and data collection. The central management location represents a physical location with a physical or postal address, deployed to manage other edge locations within the same premise or at distances apart, such as distances less than 10 kilometers.

A distributed data fabric spans the central management location and the edge locations, providing location-agnostic data access for AI agents. The distributed data fabric creates a mesh of data nodes that are deployed at edge sites or in virtual private clouds in a customer's cloud environment. The distributed data fabric enables AI agents and applications to access data without needing to know where the data is located, as long as the access is authorized. The distributed data fabric supports a virtual datastore or global namespace for data, enabling location-agnostic data access and allowing AI agents and applications to interact with data without needing to know the physical location of the data.

An orchestrator manages deployment and operation of the AI agents based on business requirements associated with the edge locations. The orchestrator generates a safe context for AI agents to operate within, where the safe context is derived from various factors including user scope and regulatory requirements. The safe context defines boundaries within which the AI agent is authorized to operate, functioning as a bounded container within which agents cannot go beyond for any execution.

The orchestrator prioritizes resources for AI agents working on high-priority business initiatives or those handling sensitive data subject to strict regulatory requirements. The orchestrator dynamically adjusts resource allocation based on real-time performance data and changing business priorities. The orchestrator implements load balancing techniques across distributed environments, distributing AI agent workloads across edge locations and centralized infrastructure based on data locality, processing requirements, and network conditions. The orchestrator facilitates coordination of multiple AI agents working on related tasks by considering interdependencies between agents and their respective business objectives. The orchestrator provides mechanisms for monitoring and reporting on service level agreement compliance, allowing administrators to track performance of AI agents against defined business objectives.

The unified platform facilitates deployment to edge locations such as manufacturing floors, healthcare centers, schools, or autonomous vehicles. The platform supports deployment to disconnected data centers suitable for government agencies or organizations with strict data sovereignty requirements. The platform allows for hybrid deployments that span multiple environment types, such as combining edge processing with centralized data center resources. The platform offers templates or pre-configured deployment patterns tailored to common use cases in different environments to accelerate deployment processes.

A cloud console establishes a secure connection to one or more deployed AI hubs, where each hub in turn manages multiple AI spokes deployed at customer edge locations. The cloud console interacts with each AI hub to provide infrastructure lifecycle management including power, update, and upgrade of the hub and all registered AI spokes. The cloud console provides application lifecycle management including install, update, and upgrade of applications on the AI hub and all associated spokes and edges. The cloud console enables setting configuration to control data security and access control across multiple managed hubs and spokes. The interaction between the cloud console and the AI hub includes requests and responses related to resource usage measures, metrics, and performance indicators of resources and applications in the hub and edges.

A trust context is established amongst the hub and all registered spokes, with access control features allowing administrators to apply strict controls to configure agent permissions to access data using data fabric application programming interfaces. The data access control system employs Access Control List statements comprising three main attributes: Subject identifying the entity requesting access, Role defining a set of permissions, and Scope specifying the entity or data resource to which permissions apply. Each AI agent within the platform is assigned a unique identifier referred to as the agent service principal, used as the Subject in Access Control List statements for granular control over agent access to data resources.

Hub and spoke processes are deployed on the same host or server to support enterprises with simpler needs, offering a simpler topology where all data resides in a lakehouse hosted from a single hub instance. A hub deployment includes fine-tuned foundation models, a knowledge base with vectorized or machine readable data aggregated from multiple edge locations, AI agents, a data fabric, and AI applications.

The AI agents use a ReAct (Reasoning+Action) technique is a powerful AI prompting method) technique to reason and act based on user input, breaking queries into multiple sub-queries and mapping the sub-queries to available toolsets to garner more context. Agents invoke a Retrieval Augmented Generation pipeline or an application programming interface query to reason better and generate responses that are grounded. Agent deployment includes a single coordinator agent functioning as a controller, one to many purpose-built or open source large language model based agents, and one to many purpose-built or open source tools. The agents deployment framework features built-in agents for accomplishing common tasks such as SQL read and write operations, reading and correlating JSON objects, sending emails, and configuring notifications in messaging platforms.

The platform parses structured output of a document processing module and ingests the structured output into multiple information storage systems including a SQL database and a knowledge graph. In the knowledge graph, entities and their relationships are dynamically generated with duplicate entities unified using unique signatures.

The platform enforces regulatory restrictions to ensure regional data related compliance policies applied at overall objects including users, data, and processing steps. A user role-based access control scope indicates a particular user's role in the platform for role-based access control. A scope of intent includes the notion of an initiative defined in the user interface of the system for that user along with the user's authorization details. Additional scope criteria include entities, knowledge graphs, relations, and personal data.

The platform automatically generates monitoring profiles for applications, platform components, and infrastructure elements based on customer intent, application specifications, resource usage metrics, and infrastructure performance data. The platform employs adaptive learning techniques to refine and adjust monitoring profiles over time based on historical data and observed patterns. The adaptive learning process analyzes the effectiveness of existing monitoring rules and thresholds, evaluating frequency and accuracy of alerts to automatically adjust alert thresholds or modify monitoring rules. The platform provides mechanisms for operational users, application developers, or customers to provide feedback on monitoring alerts through natural language inputs. The system analyzes operational costs associated with responding to different types of alerts and adjusts monitoring thresholds accordingly to optimize resource utilization. The auto-generated monitoring profiles are tailored to specific application types or deployment environments, generating different profiles for edge deployments compared to cloud-based deployments. The platform provides visualization tools and dashboards to help users understand performance of AI deployments and effectiveness of auto-generated monitoring profiles.

A workflow suggestion system presents users with multiple options including low-cost, optimal, and fine-fit solutions with different resource and complexity tradeoffs. Users have the ability to view suggested workflows through a graphical user interface or access workflow details programmatically via application programming interfaces. Users edit workflows by adding manual intervention steps or configuring criteria for when these steps are executed. The system offers a validation process for modified workflows to ensure compatibility with platform capabilities and organization requirements.

A one-click move process checks whether appropriate data controls are enabled for the application to work in the edge node and whether there are appropriate resources at the edge node. If data controls are not enabled, the system informs the user to fix that first. If there is a lack of resources, the system indicates what resources are needed for the operation to succeed. The platform shuts down the instance on the cloud, procures and transfers the metadata associated with the application into the edge, and instantiates the application on the edge node. A porting agent with help from the saved application configurations, discovers dependencies for the application including Helm charts, docker images, and additional core dependencies. The system automatically generates location-specific values and endpoints to ensure proper configuration for each deployment environment.

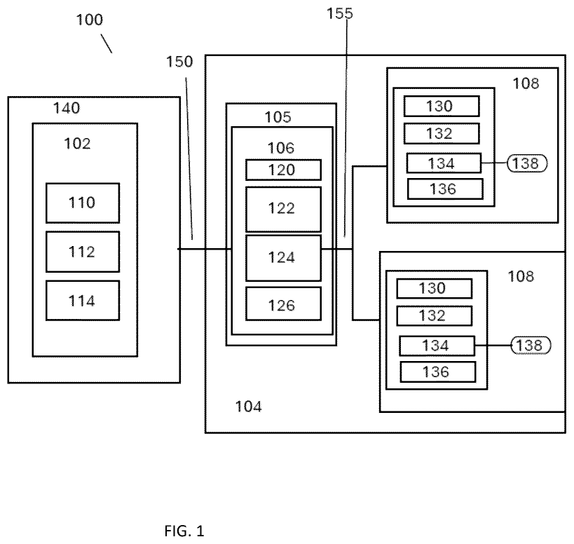

Referring to FIG. 1, a deployment system 100 for deploying and operating AI agents across distributed environments employs a hub-and-spoke architecture. The deployment system 100 comprises three main sections: a cloud console 102, a customer VPC/datacenter 104, and a plurality of edge locations 108. The cloud console 102 is hosted by a service provider in a virtual private cloud and establishes a secure connection to one or more deployed AI Hubs. Each AI Hub in turn manages multiple AI Spokes deployed at the customer's edge locations 108.

The customer VPC/datacenter 104 includes a central management location 106, which functions as the AI Hub in the hub-and-spoke architecture. The central management location 106 represents a physical location with a physical or postal address, deployed to manage other edge locations 108 within the same premise or at distances apart, such as distances less than 10 kilometers. The central management location 106 coordinates AI deployments and handles complex or resource-intensive tasks while the edge locations 108 perform local processing and data collection.

With continued reference to FIG. 1, the cloud console 102 includes a dashboard/cockpit 110, a billing module 112, and a location and apps module 114. The dashboard/cockpit 110 shows an aggregated view of all customer assets to allow an administrator to control the state of the systems and apply security controls by executing commands over a secure channel established between the cloud console 102 and each AI hub. The billing module 112 provides a billing view showing units of measure and overall price for the month. The location and apps module 114 shows all deployed locations and their associated performance indicators and lists deployed application instances.

The cloud console 102 interacts with each AI hub to provide infrastructure lifecycle management including power, update, and upgrade of the hub and all registered AI spokes. The cloud console 102 provides application lifecycle management including install, update, and upgrade of applications on the AI hub and all associated spokes and edges. The cloud console 102 enables setting configuration to control data security and access control across multiple managed hubs and spokes. The interaction between the cloud console 102 and the AI hub includes requests and responses related to resource usage measures, metrics, and performance indicators of resources and applications in the hub and edges.

As further shown in FIG. 1, the central management location 106 contains an AI apps database 120, an AI orchestrator 122, AI foundational services 124, and AI core infrastructure services 126. The AI orchestrator 122 takes user input and queries and creates a workflow in the form of graphs, which are then executed in sequence or parallel in an iterative process until satisfactory accuracy is achieved. The AI foundational services 124 represent a set of core services offering different capabilities including large language model based agent deployment for reasoning and a pipeline framework for execution of directed acyclic graph based steps. The AI core infrastructure services 126 include fundamental services required to host foundational services such as data fabric and GPU management services.

Each edge location 108 contains edge AI apps 130, AI agents and workflows 132, a device controller 134, and minimal infrastructure services 136. The device controller 134 represents a device manager module that interfaces with various input/output devices 138 including audio, text, video, and IoT devices. The device controller 134 enables integration of diverse data sources at the edge location 108. The central management location 106 communicates with the edge locations 108 through data and API request pathways.

Hub and spoke processes are deployed on the same host or server to support enterprises with simpler needs, offering a simpler topology where all data resides in a lakehouse hosted from a single hub instance. A hub deployment includes fine-tuned foundation models, a knowledge base with vectorized or machine readable data aggregated from multiple edge locations 108, AI agents, a data fabric, and AI applications. A trust context is established amongst the hub and all registered spokes, with access control features allowing administrators to apply strict controls to configure agent permissions to access data using data fabric application programming interfaces.

Referring to FIG. 1, the cloud console 102 includes three components that provide centralized management capabilities for the deployment system 100. The dashboard/cockpit 110 displays an aggregated view of all customer assets across the deployment system 100, enabling an administrator to monitor and control the state of systems deployed at the central management location 106 and the edge locations 108. The dashboard/cockpit 110 provides controls for applying security configurations by executing commands over a secure command and control channel established between the cloud console 102 and each AI hub deployed at the central management location 106.

The billing module 112 provides billing information to administrators, displaying units of measure for resource consumption and overall pricing for billing periods. The location and apps module 114 displays all deployed locations within the deployment system 100 along with associated performance indicators for each location. The location and apps module 114 also lists deployed application instances running on the central management location 106 and the edge locations 108.

With continued reference to FIG. 1, the central management location 106 contains four components that provide AI deployment and management capabilities. The AI apps database 120 stores application data and configurations for AI applications deployed across the deployment system 100. The AI orchestrator 122 receives user input and queries and creates workflows in the form of graphs. The AI orchestrator 122 executes the graphs in sequence or parallel, with the process being iterative such that the AI orchestrator 122 continues execution until satisfactory accuracy is achieved for a response returned to the end user.

The AI foundational services 124 represent a set of core services that offer different capabilities to solve business problems. The AI foundational services 124 include large language model based agent deployment that offers the capability to reason based on context and respond to queries. The AI foundational services 124 also include a pipeline framework that allows execution of directed acyclic graph based steps to accomplish business outcomes. The directed acyclic graph based pipeline framework enables sequential and parallel execution of processing steps according to defined dependencies between steps.

As further shown in FIG. 1, the AI core infrastructure services 126 include fundamental services required to host the AI foundational services 124. The AI core infrastructure services 126 include a data fabric service that provides data access capabilities across the deployment system 100. The AI core infrastructure services 126 also include GPU management services that allocate and manage graphics processing unit resources for AI workloads running on the central management location 106.

The cloud console 102 interacts with the central management location 106 to provide infrastructure lifecycle management operations. Infrastructure lifecycle management includes power management, updates, and upgrades of the central management location 106 and all registered AI spokes at the edge locations 108. The cloud console 102 transmits commands over the secure command and control channel to initiate power operations, apply software updates, and perform system upgrades across the deployment system 100. For example, to reduce cost and power optimizations during non-busy hours, a GPU node may be shut down if the usage is below systems baseline capacity.

The cloud console 102 provides application lifecycle management for AI applications deployed across the deployment system 100. Application lifecycle management includes installation, update, and upgrade of applications on the central management location 106 and all associated edge locations 108. The cloud console 102 coordinates application deployment workflows to ensure consistent application versions across the hub and spoke architecture.

The cloud console 102 enables configuration of data security and access control settings across multiple managed hubs and spokes within the deployment system 100. Administrators use the cloud console 102 to define security policies that are propagated to the central management location 106 and the edge locations 108. The security configuration controls data access permissions and enforces access control policies across the distributed environment.

The interaction between the cloud console 102 and the central management location 106 includes exchange of resource usage measures, metrics, and performance indicators. The central management location 106 transmits resource usage data for applications and infrastructure components to the cloud console 102. The cloud console 102 receives performance metrics from the edge locations 108 through the central management location 106, enabling centralized monitoring of the entire deployment system 100.

With continued reference to FIG. 1, the edge locations 108 function as AI spokes in the hub-and-spoke architecture of the deployment system 100. Each edge location 108 contains the edge AI apps 130, the AI agents and workflows 132, the device controller 134, and the minimal infrastructure services 136. The edge locations 108 perform local processing and data collection while the central management location 106 handles complex or resource-intensive tasks. The hub-and-spoke architecture distributes AI processing capabilities across the deployment system 100, with the central management location 106 coordinating operations across all registered edge locations 108.

The device controller 134 represents a device manager module that interfaces with the input/output devices 138. The input/output devices 138 include Audio devices, Text devices, Video devices, and IoT devices. The device controller 134 enables integration of diverse data sources at each edge location 108 by managing connections to the input/output devices 138. Audio devices connected through the device controller 134 capture and process audio data streams for AI agent consumption. Text devices interface with the device controller 134 to provide textual input data from various sources. Video devices connected to the device controller 134 supply video streams and image data for processing by the AI agents and workflows 132. IoT devices communicate with the device controller 134 to transmit sensor data and receive control commands from AI agents operating at the edge location 108.

The edge AI apps 130 store application data and configurations for AI applications deployed at each edge location 108. The AI agents and workflows 132 execute AI processing tasks locally at the edge location 108, receiving data from the device controller 134 and communicating with the central management location 106 through data and API request pathways. The minimal infrastructure services 136 provide fundamental runtime services required to support the edge AI apps 130 and the AI agents and workflows 132 at each edge location 108.

As further shown in FIG. 1, the deployment system 100 supports deployment of hub and spoke processes on the same host or server to support enterprises with simpler needs. This single-host deployment offers a simpler topology where all data resides in a lakehouse hosted from a single hub instance. Enterprises that do not require segmentation of their industrial space utilize this single-host configuration, with the central management location 106 and edge location 108 processes running on shared hardware.

The central management location 106 represents a physical location with a physical or postal address. The central management location 106 is deployed to manage other edge locations 108 within the same premise or at distances apart, such as distances less than 10 kilometers. This physical proximity consideration enables low-latency communication between the central management location 106 and the edge locations 108 while maintaining centralized coordination of AI deployments.

A hub deployment at the central management location 106 includes fine-tuned foundation models that provide reasoning capabilities for AI agents. The hub deployment includes a knowledge base with vectorized or machine readable data aggregated from multiple edge locations 108. The hub deployment also includes AI agents, a data fabric for distributed data access, and AI applications that execute on the central management location 106.

A trust context is established amongst the central management location 106 and all registered edge locations 108 functioning as spokes. Access control features allow administrators to apply strict controls to configure agent permissions to access data using data fabric application programming interfaces. The trust context defines the security boundaries within which AI agents at the edge locations 108 operate when accessing data through the distributed data fabric spanning the deployment system 100.

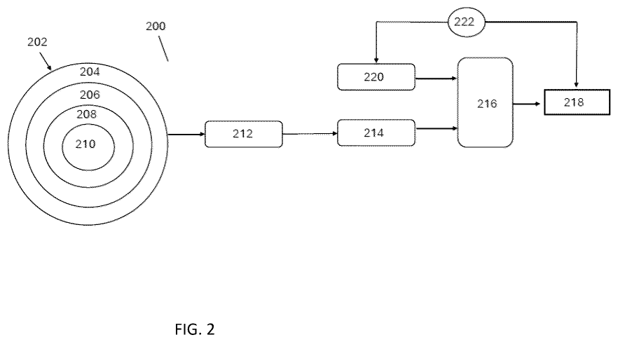

Referring to FIG. 2, an AI agent platform 200 generates a safe context for LLM-based agents to operate within defined boundaries. The AI agent platform 200 illustrates the flow from administrative configuration through to response generation, enabling enterprises to control the scope within which AI agents execute operations. A customer admin 202 controls a number of scopes that are relevant to particular AI agent operations, particular users, particular locations, or other details of operations to be performed at particular edge locations.

The customer admin 202 controls a user RBAC scope 204 that indicates a particular user's role in the AI agent platform 200 for role-based access control. The user RBAC scope 204 defines permissions associated with user roles, enabling the AI agent platform 200 to restrict AI agent operations based on the role assigned to each user. Role-based access control through the user RBAC scope 204 ensures that AI agents operate within authorization boundaries corresponding to the user initiating requests.

With continued reference to FIG. 2, the customer admin 202 controls a compliance regulatory scope 206 that includes criteria beyond user roles. The compliance regulatory scope 206 enforces regulatory restrictions to ensure regional data related compliance policies applied at overall objects including users, data, and processing steps. The AI agent platform 200 applies the compliance regulatory scope 206 to restrict AI agent access to data based on geographic or jurisdictional requirements. Regional data compliance enforcement through the compliance regulatory scope 206 prevents AI agents from accessing or processing data in violation of applicable regulations.

The customer admin 202 controls a scope of intent 208 that indicates the user's intent or goal within the AI agent platform 200. The scope of intent 208 includes the notion of an initiative defined in the user interface of the system for that user along with the user's authorization details. Initiative-based scope definition through the scope of intent 208 constrains AI agent operations to activities aligned with defined business objectives. The scope of intent 208 enables the AI agent platform 200 to generate context boundaries that correspond to specific projects or business initiatives. Scope examples could be ‘compliance,’ ‘security,’ ‘operational efficiencies’ etc. Accordingly, the fine-tuned layers of models are prepared and deployed.

As further shown in FIG. 2, the customer admin 202 controls entities knowledge graphs 210 that provide additional scope criteria. The entities knowledge graphs 210 include entities, knowledge graphs, relations, and personal data as scope criteria for AI agent operations. Knowledge graph scope criteria through the entities knowledge graphs 210 define which data entities and relationships AI agents are authorized to access and process. The entities knowledge graphs 210 enable fine-grained control over AI agent access to structured knowledge representations within the AI agent platform 200.

From the user RBAC scope 204, the compliance regulatory scope 206, the scope of intent 208, and the entities knowledge graphs 210 considered by the customer admin 202, the AI agent platform 200 generates an LLM safe context 212 for LLM-based agents to execute within. The LLM safe context 212 functions as a bounded container within which agents cannot go beyond for any execution. The LLM safe context 212 defines the constraints that translate into prompts and guard-rails for LLM-based agents operating within the AI agent platform 200.

With continued reference to FIG. 2, the AI agent platform 200 uses the LLM safe context 212 when generating system prompts 214 associated with deploying an AI application to a location. The system prompts 214 incorporate the boundaries defined by the LLM safe context 212 to constrain LLM-based agent behavior during execution. An LLM based agent 216 processes the system prompts 214 to provide a grounded and secure response 218 to user queries. The grounded and secure response 218 reflects the constraints imposed by the LLM safe context 212, ensuring that responses remain within authorized boundaries.

The grounded and secure response 218 is used in an iterative manner to elicit human prompts 220 from users. The human prompts 220 are processed by the LLM based agent 216 in combination with the system prompts 214 to refine the grounded and secure response 218. This iterative process continues until a satisfactory response is achieved, with the LLM based agent 216 operating within the boundaries defined by the LLM safe context 212 throughout the interaction.

Agent deployment within the AI agent platform 200 includes a single coordinator agent functioning as a controller, one to many purpose-built or open source LLM-based agents, and one to many purpose-built or open source tools. Requests from users in an AI assistant application are handled by the coordinator agent. The coordinator agent generates the LLM safe context 212 for the rest of query executions and creates a query execution plan. The coordinator agent executes queries and breaks queries down further until a satisfactory response is arrived at through the iterative process.

The agents deployment framework within the AI agent platform 200 features built-in agents for accomplishing common tasks. Built-in agents perform SQL read and write operations, reading and correlating JSON objects, sending emails, and configuring notifications in messaging platforms such as Slack and Pagerduty. The AI agent platform 200 parses structured output of a document processing module and ingests the structured output into multiple information storage systems including a SQL database and a knowledge graph. In the knowledge graph, entities and their relationships are dynamically generated with duplicate entities unified using unique signatures.

With continued reference to FIG. 2, the LLM safe context 212 operates as a bounded container that constrains agent execution within defined boundaries. The LLM safe context 212 prevents agents from accessing information or performing operations outside the authorized scope established by the customer admin 202 through the user RBAC scope 204, the compliance regulatory scope 206, the scope of intent 208, and the entities knowledge graphs 210. The bounded container structure of the LLM safe context 212 ensures that LLM-based agents do not accept or access information that is not authorized within the safe context boundaries.

The AI agent platform 200 generates the system prompts 214 based on the constraints defined within the LLM safe context 212. The system prompts 214 translate the scope constraints into prompts and guard-rails that govern LLM-based agent behavior during query execution. The LLM based agent 216 processes the system prompts 214 to produce the grounded and secure response 218 that adheres to the boundaries established by the LLM safe context 212. The grounded and secure response 218 reflects the authorization constraints imposed through the safe context generation process.

As further shown in FIG. 2, the iterative refinement process uses the human prompts 220 to improve response quality while maintaining safe context boundaries. Users provide the human prompts 220 through an AI assistant application interface. The LLM based agent 216 processes the human prompts 220 in combination with the system prompts 214 to refine the grounded and secure response 218. This iterative process continues through multiple cycles until the LLM based agent 216 achieves a satisfactory response accuracy. Throughout the iterative refinement process, the LLM based agent 216 operates within the boundaries defined by the LLM safe context 212.

The AI agents within the AI agent platform 200 use a ReAct technique to reason and act based on user input. The ReAct technique enables AI agents to break queries into multiple sub-queries for processing. Each sub-query is mapped by the agent to available toolsets to garner additional context for improved reasoning. The agent uses cognitive ability to identify the best toolset match for each sub-query, enabling the agent to gather context information that supports grounded response generation.

With continued reference to FIG. 2, agents invoke a Retrieval Augmented Generation pipeline or an application programming interface query to reason better and generate responses that are grounded. The Retrieval Augmented Generation pipeline retrieves relevant information from knowledge bases and data sources to augment the reasoning process. Application programming interface queries enable agents to access external data sources and services to gather context information. The combination of Retrieval Augmented Generation and application programming interface queries enables the LLM based agent 216 to generate the grounded and secure response 218 that is anchored in retrieved factual information.

Agent deployment within the AI agent platform 200 includes a single coordinator agent that functions as a controller for multi-agent operations. The coordinator agent handles requests from users in the AI assistant application and generates the LLM safe context 212 for subsequent query executions. The coordinator agent creates a query execution plan that defines the sequence of operations to be performed by subordinate agents. Agent deployment also includes one to many purpose-built or open source LLM-based agents that perform specialized reasoning tasks. Agent deployment further includes one to many purpose-built or open source tools that provide specific capabilities for agent operations.

The coordinator agent executes queries according to the query execution plan and breaks queries down further as needed. The coordinator agent iterates through the query execution process until a satisfactory response is achieved. The coordinator agent governs the entire multi-agent process, ensuring that all subordinate agents operate within the boundaries defined by the LLM safe context 212.

The agents deployment framework within the AI agent platform 200 features built-in agents for accomplishing common tasks. Built-in agents perform SQL read and write operations against database systems. Built-in agents read and correlate JSON objects from various data sources. Built-in agents send emails through configured email services. Built-in agents configure notifications in messaging platforms including Slack and Pagerduty. The built-in agents for common tasks reduce the need for custom agent development for standard operations within the AI agent platform 200.

With continued reference to FIG. 2, the AI agent platform 200 parses structured output from a document processing module and ingests the structured output into multiple information storage systems. The multiple information storage systems include a SQL database and a knowledge graph. The dual storage strategy combines the strengths of relational databases and semantic graph structures to support different types of data access and reasoning operations.

Data ingestion involves extracting structured information from processed documents and transforming the structured information into formats suitable for each storage system. In the SQL database, data is organized into well-defined tables and schemas for efficient querying and analytics. The SQL database stores structured data in tabular format with defined relationships between tables, enabling precise queries against the stored information.

In the knowledge graph, entities and their relationships are dynamically generated from the processed document output. The knowledge graph stores semantic relationships between entities, enabling relationship exploration and contextual reasoning across connected data elements. Duplicate entities within the knowledge graph are unified using unique signatures that identify equivalent entities across different data sources. The unique signature approach ensures that the same real-world entity represented in multiple documents or data sources is consolidated into a single node within the knowledge graph structure.

The entity deduplication process using unique signatures prevents redundant entity nodes from accumulating within the knowledge graph. Each entity receives a unique signature based on identifying attributes extracted from the source documents. When new entities are ingested into the knowledge graph, the unique signatures are compared against existing entities to identify matches. Matching entities are unified rather than duplicated, maintaining a clean and consistent knowledge graph structure.

As further shown in FIG. 2, the LLM based agent 216 accesses the stored data within both the SQL database and the knowledge graph to support query processing. The LLM based agent 216 leverages the SQL database for precise, tabular queries that retrieve specific data values and aggregations. The LLM based agent 216 leverages the knowledge graph for semantic reasoning and relationship exploration that traverses connections between entities.

The LLM based agent 216 answers complex questions by integrating structured data from the SQL database with contextual understanding from the knowledge graph. The LLM based agent 216 identifies patterns across the stored data by combining tabular query results with relationship traversals. The LLM based agent 216 provides actionable insights by synthesizing information retrieved from both storage systems into the grounded and secure response 218.

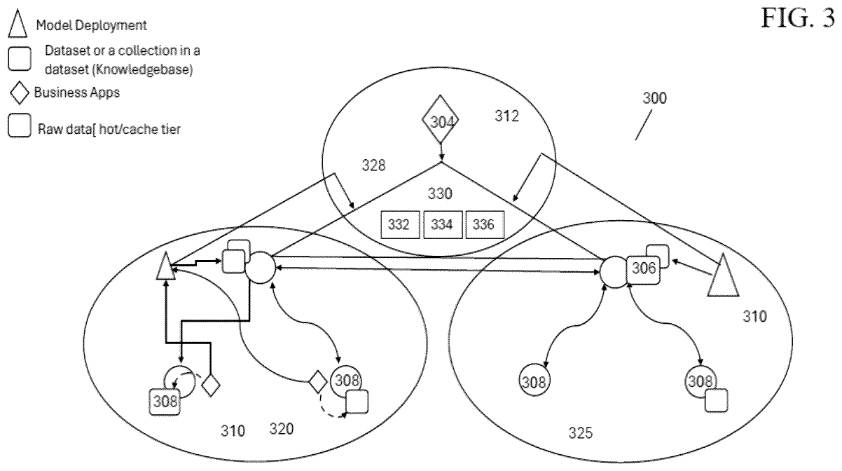

Referring to FIG. 3, a distributed data fabric architecture 300 enables data access and management across multiple deployment locations within the deployment system 100. The distributed data fabric architecture 300 includes a data orchestration network 302 that connects an application node 304 to a plurality of controller data nodes 306, which in turn communicate with one or more data nodes 308. The distributed data fabric architecture 300 is organized into multiple trust zones, including data node trust zones 310 and an application node trust zone 312.

The data orchestration network 302 serves as a cross-site data fabric that provides interfaces for data access, including S3, NFS, and POSIX protocols. The data orchestration network 302 facilitates communication between the application node 304 and the controller data nodes 306 while maintaining appropriate security boundaries between the different trust zones. The data orchestration network 302 enables AI agents operating within the deployment system 100 to access data without knowledge of the physical location of the data.

With continued reference to FIG. 3, the application node 304 resides within the application node trust zone 312 and represents a node profile that is applied to nodes in the deployment system 100. The application node 304 is configured as an application-only node that does not participate in data exchanges with other nodes, though being part of the distributed data fabric architecture 300 allows the application node 304 to access data from the data nodes 308. The application node trust zone 312 defines security boundaries for application execution separate from data storage operations.

Each controller data node 306 acts as a controller within its respective data node trust zone 310 and connects to other data nodes 308 within the same zone in a hierarchical arrangement. The controller data nodes 306 serve to manage data access and coordination within their respective data node trust zones 310. The hierarchical arrangement of the controller data nodes 306 and the data nodes 308 within each data node trust zone 310 allows for efficient data management and access control.

Further as shown in FIG. 3, the data nodes 308 are distributed across the data node trust zones 310 and store and process data for AI agents and applications. Some data nodes 308 connect to time-sensitive applications that require low-latency data access. The distributed data fabric architecture 300 incorporates raw data, hot, and cache tier storage components to optimize data access and processing performance. The raw data tier stores unprocessed data in its original format. The hot tier stores frequently accessed data for rapid retrieval. The cache tier provides temporary storage for data that is actively being processed by AI agents.

The data node trust zones 310 define security boundaries within which the controller data nodes 306 and the data nodes 308 operate. Each data node trust zone 310 contains one controller data node 306 that coordinates operations for all data nodes 308 within that zone. The hierarchical structure enables the controller data node 306 to enforce access control policies and manage data replication within its data node trust zone 310.

With continued reference to FIG. 3, communication paths between nodes enable data transfer and coordination between components within and across the data node trust zones 310 and the application node trust zone 312. The communication paths support location-agnostic data access for AI agents and applications deployed across the distributed environment. The distributed data fabric architecture 300 supports a virtual datastore or global namespace for data, enabling AI agents to interact with data without knowledge of the physical location of the data within the data nodes 30 The way the virtual datastore or global namespace is implemented by maintaining a map/index of data across all the edge/hub deployments. The current invention use a heartbeat based algorithm to transmit “new data,” “changed data” for the global namespace to reconcile and prepare an index. The data is organized by context than the location where it had originated.

With continued reference to FIG. 3, the data orchestration network 302 provides interfaces for applications to interact with the distributed data fabric architecture 300. The data orchestration network 302 provides SQL interfaces that enable applications to execute structured queries against data stored within the data nodes 308. The data orchestration network 302 provides NFS interfaces that enable applications to access data through network file system protocols. The data orchestration network 302 provides POSIX interfaces that enable applications to access data through standard file system operations. The multi-protocol interface support enables AI agents and applications to access data using the protocol that is appropriate for each application's requirements.

The application node 304 represents an additional profile that is applied to any node in the deployment system 100. A data node within the distributed data fabric architecture 300 participates in data storage and exchange of data into and out of the fabric. The application node 304 is configured as an application-only node with no or minimum storage that does not participate in data exchanges with other nodes. Node profile flexibility enables nodes within the distributed data fabric architecture 300 to serve as data nodes participating in data storage operations and/or as application nodes that execute applications without data storage responsibilities. A node could be an application node and act as a data node as well.

As further shown in FIG. 3, a coordinator within the distributed data fabric architecture 300 is an elected primary node in the fabric that keeps data connections to the data nodes 308 active. The coordinator sends and receives heartbeats from other nodes within the distributed data fabric architecture 300. The coordinator advertises the status of the fabric to clients that access data through the data orchestration network 302. The heartbeat mechanism enables the coordinator to monitor the availability of all nodes within the distributed data fabric architecture 300 and detect when nodes become unavailable.

Each data node in the distributed data fabric architecture 300 is hosted on an application runtime having built-in coordinator, data authorizer, and data-gateway components. The built-in coordinator component enables each data node to participate in coordinator election and fabric coordination operations. The built-in data authorizer component enables each data node to validate data access requests against access control policies. The built-in data-gateway component enables each data node to route data requests to appropriate storage locations within the distributed data fabric architecture 300.

With continued reference to FIG. 3, as part of the boot process, each node joins the fabric within the distributed data fabric architecture 300. In cases where no fabric is detected during the boot process, the node initiates fabric creation and advertises coordinator endpoints inviting other data nodes to join when the other data nodes become available. The auto fabric initialization during the boot process enables the distributed data fabric architecture 300 to self-organize without manual configuration of fabric membership.

When a node is down at a location within the distributed data fabric architecture 300, the coordinator is responsible to detect the unavailable node and repair the paths so that AI applications and agents from one location continue to work accessing the latest available data. The automatic path repair enables the distributed data fabric architecture 300 to maintain data accessibility when individual nodes experience failures or become unreachable. The coordinator reconfigures data access paths to route requests around unavailable nodes to nodes that hold replicated copies of the requested data.

The freshness of data within the distributed data fabric architecture 300 is limited to the availability of the target data node which is the primary holder of that data. Until the primary data node becomes available, a secondary replica serves the latest synchronized data to the consumer. The secondary replica failover enables the distributed data fabric architecture 300 to maintain data availability when primary data nodes are unavailable. The secondary replica contains data that was synchronized from the primary data node prior to the primary data node becoming unavailable, ensuring that AI agents and applications continue to access data during node outages.

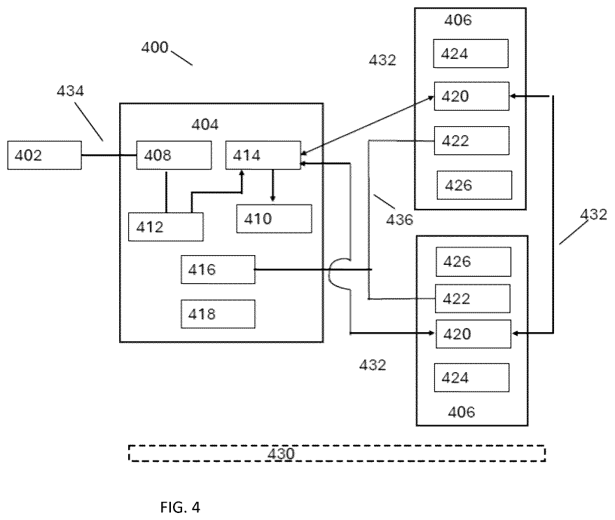

Referring to FIG. 4, a distributed data access architecture 400 implements enterprise controls for data serving and access within the deployment system 100. The distributed data access architecture 400 enforces access control policies for AI agents accessing data through the distributed data fabric architecture 300. The distributed data access architecture 400 includes customer directory services 402, an authentication link 404, a coordinator 416, a local authentication module 408, an authorizer 410, apps/agents 412, a data access gateway 414, and a datastore 418.

The customer directory services 402 connects to the coordinator 416 through the authentication link 404. The customer directory services 402 provides identity information for users and AI agents that request access to data within the distributed data access architecture 400. The authentication link 404 establishes a secure connection between the customer directory services 402 and the coordinator 416 for transmitting authentication credentials and identity verification requests.

With continued reference to FIG. 4, the coordinator 416 resides within a central data node structure that contains the local authentication module 408, the authorizer 410, the apps/agents 412, the data access gateway 414, and the datastore 418. The coordinator 416 maintains the overall state and availability status of all nodes participating in the distributed data fabric architecture 300. The coordinator 416 sends membership advertisements to follower nodes and receives heartbeat signals from nodes within the fabric.

The local authentication module 408 interfaces with the authentication link 404 to handle authentication processes for data access requests. The local authentication module 408 validates credentials received through the authentication link 404 against identity information provided by the customer directory services 402. The local authentication module 408 verifies that requesting entities possess valid credentials before forwarding requests to the authorizer 410 for access control evaluation.

As further shown in FIG. 4, the authorizer 410 works in conjunction with the data access gateway 414 to validate and authorize data access requests from AI agents. The authorizer 410 evaluates data access requests against defined access control policies before granting access or forwarding requests to other data nodes within the distributed data access architecture 400. The authorizer 410 enforces access control policies that restrict AI agent access to authorized data resources.

The data access gateway 414 routes data access requests from the apps/agents 412 to appropriate data storage locations within the distributed data access architecture 400. The data access gateway 414 interfaces with the authorizer 410 to validate requests against access control policies before routing requests to the datastore 418 or to other data nodes. The data access gateway 414 provides a single point of entry for data access requests from AI agents operating within the distributed data access architecture 400.

With continued reference to FIG. 4, the apps/agents 412 represent AI applications and agents that request access to data through the data access gateway 414. The apps/agents 412 submit data access requests that are routed through the data access gateway 414 and validated by the authorizer 410 before access is granted. The datastore 418 stores data that is accessed by the apps/agents 412 through the data access gateway 414.

The distributed data access architecture 400 employs Access Control List statements comprising three main attributes: Subject, Role, and Scope. The Subject attribute identifies the entity requesting access, such as an AI agent, application instance, or user identifier. The Role attribute defines a set of permissions associated with the Subject. The Scope attribute specifies the entity or data resource to which the permissions apply. The three-attribute Access Control List structure enables fine-grained control over data access within the distributed data access architecture 400.

As further shown in FIG. 4, each AI agent within the distributed data access architecture 400 is assigned a unique identifier referred to as the agent service principal. The agent service principal is used as the Subject in Access Control List statements for granular control over agent access to data resources. The agent service principal enables the authorizer 410 to identify individual AI agents and evaluate access requests against Access Control List statements that specify permissions for each agent. The unique agent service principal assignment ensures that each AI agent operates under distinct access control policies defined through Access Control List statements within the distributed data access architecture 400.

With continued reference to FIG. 4, the distributed data access architecture 400 includes a plurality of data nodes 406 that are distributed throughout the architecture and communicate with the coordinator 416. Each data node 406 contains data node components 420 that provide data storage and access capabilities within the distributed data access architecture 400. The data node components 420 include applications, a data access gateway, a data agent, a datastore, and a data node element that collectively enable data operations at each data node 406.

Data requests 422 flow between the coordinator 416 and the various data nodes 406, enabling data exchange across the distributed environment. The data requests 422 carry data access operations from the apps/agents 412 through the coordinator 416 to the data nodes 406 that store the requested data. The data requests 422 also carry response data from the data nodes 406 back through the coordinator 416 to the requesting apps/agents 412.

As further shown in FIG. 4, a data agent 424 within each data node 406 facilitates data operations and communication with other nodes in the fabric. The data agent 424 processes incoming data requests 422 and coordinates data retrieval and storage operations within the data node 406. The data agent 424 communicates with data agents in other data nodes 406 to support distributed data operations that span multiple nodes within the distributed data access architecture 400.

Inter-node advertisements 426 represent communication pathways between the coordinator 416 and the data nodes 406. The inter-node advertisements 426 allow the coordinator 416 to send membership advertisements to follower nodes within the distributed data access architecture 400. The inter-node advertisements 426 enable the coordinator 416 to maintain awareness of node status throughout the fabric by receiving heartbeat signals and status updates from each data node 406. The membership advertisement mechanism through the inter-node advertisements 426 ensures that all nodes within the distributed data access architecture 400 maintain consistent knowledge of fabric membership and node availability.

With continued reference to FIG. 4, a virtual datastore 430 encompasses the entire distributed data access architecture 400 and provides an abstraction layer for data access. The virtual datastore 430 enables applications to access data without knowledge of the underlying distributed nature of data storage across multiple data nodes 406. The virtual datastore 430 serves as an entity that an application reads from and writes to without knowing how and from where the data is sourced. The virtual datastore 430 supports application mobility without requiring copy-over of data along with the application across edge nodes within the deployment system 100.

The distributed data access architecture 400 allows multiple roles or profiles for nodes within the fabric. Each node in the distributed data access architecture 400 assumes one or more profiles depending on the configuration. Node roles include Data Node, Data Node Controller functioning as Master, Data Node Follower, and Application Node. The Data Node role enables a node to participate in data storage and exchange of data into and out of the fabric. The Data Node Controller role designates a node as the master that coordinates operations across the fabric. The Data Node Follower role designates a node that follows the coordination of the master controller. The Application Node role enables a node to execute applications without participating in data storage operations.

As further shown in FIG. 4, a Controller node ensures the overall state and availability status of all nodes participating in the fabric within the distributed data access architecture 400. The Controller node is responsible for Access Control List propagation across the fabric to allow or deny data access. The Controller node propagates Access Control List statements to all data nodes 406 within the distributed data access architecture 400, ensuring consistent enforcement of access control policies across the distributed environment. The Access Control List propagation by the Controller node ensures that all data nodes 406 enforce identical access control policies when the authorizer 410 evaluates data access requests from AI agents.

With continued reference to FIG. 1, the AI orchestrator 122 within the central management location 106 provides business SLA-driven agent management capabilities for AI agents deployed across the deployment system 100. The AI orchestrator 122 prioritizes resources for AI agents working on high-priority business initiatives. The AI orchestrator 122 also prioritizes resources for AI agents handling sensitive data subject to strict regulatory requirements. Priority-based resource allocation through the AI orchestrator 122 ensures that AI agents associated with high-priority business objectives receive computing resources ahead of lower-priority workloads within the deployment system 100.

The AI orchestrator 122 dynamically adjusts resource allocation based on real-time performance data collected from the central management location 106 and the edge locations 108. The AI orchestrator 122 monitors performance metrics including processing latency, throughput, and resource utilization across the deployment system 100. The AI orchestrator 122 adjusts resource allocation based on changing business priorities that are communicated through the cloud console 102. Dynamic resource adjustment enables the AI orchestrator 122 to respond to fluctuating workload demands and shifting business requirements without manual intervention.

As further shown in FIG. 1, the AI orchestrator 122 implements load balancing techniques across the distributed environments within the deployment system 100. The AI orchestrator 122 distributes AI agent workloads across the edge locations 108 and the central management location 106 based on data locality considerations. Data locality-based distribution places AI agent workloads at locations where the data required for processing resides, reducing data transfer latency and network bandwidth consumption. The AI orchestrator 122 considers processing requirements when distributing workloads, assigning compute-intensive tasks to locations with sufficient processing capacity within the AI core infrastructure services 126.

The AI orchestrator 122 evaluates network conditions when distributing AI agent workloads across the deployment system 100. Network condition evaluation includes assessment of bandwidth availability, latency measurements, and connection reliability between the central management location 106 and the edge locations 108. The AI orchestrator 122 routes workloads to avoid congested network paths and to minimize communication delays between AI agents and data sources. Load balancing across the distributed environment optimizes resource utilization while maintaining performance levels defined by business service level agreements.

Referring to FIG. 2, the AI orchestrator 122 uses the LLM safe context 212 generated by the AI agent platform 200 when making resource allocation decisions. The AI orchestrator 122 considers the user RBAC scope 204, the compliance regulatory scope 206, the scope of intent 208, and the entities knowledge graphs 210 when prioritizing resources for AI agents. Resource prioritization based on the LLM safe context 212 ensures that AI agents handling sensitive data receive appropriate resource allocations that support compliance with regulatory requirements defined within the compliance regulatory scope 206.

With continued reference to FIG. 2, the AI orchestrator 122 facilitates coordination of multiple AI agents working on related tasks within the AI agent platform 200. The AI orchestrator 122 considers interdependencies between AI agents when scheduling and coordinating multi-agent operations. Interdependency consideration includes identification of data dependencies where one AI agent produces output that serves as input for another AI agent. The AI orchestrator 122 sequences AI agent execution to ensure that dependent agents receive required input data before execution begins.

The AI orchestrator 122 considers business objectives associated with each AI agent when coordinating multi-agent operations. Business objective consideration includes alignment of agent execution schedules with initiative timelines defined within the scope of intent 208. The AI orchestrator 122 coordinates AI agents working toward common business objectives to optimize collective progress toward defined goals. Multi-agent coordination through the AI orchestrator 122 reduces resource contention between agents and improves overall system throughput within the deployment system 100.

Referring to FIG. 3, the AI orchestrator 122 coordinates AI agent workloads across the distributed data fabric architecture 300. The AI orchestrator 122 considers data locality within the data node trust zones 310 when distributing AI agent workloads. Data locality consideration places AI agent execution at locations proximate to the data nodes 308 that store data required for agent processing. The AI orchestrator 122 routes workloads to the application node 304 or to processing resources within the data node trust zones 310 based on data access patterns and processing requirements.

With continued reference to FIG. 3, the AI orchestrator 122 monitors data access patterns across the data orchestration network 302 to inform load balancing decisions. The AI orchestrator 122 identifies frequently accessed data within the data nodes 308 and positions AI agent workloads to minimize data transfer across the data orchestration network 302. The AI orchestrator 122 considers the hierarchical structure of the controller data nodes 306 and the data nodes 308 when distributing workloads within each data node trust zone 310.

Referring to FIG. 4, the AI orchestrator 122 coordinates with the coordinator 416 within the distributed data access architecture 400 to manage AI agent workloads. The AI orchestrator 122 receives node availability information from the coordinator 416 through the inter-node advertisements 426. Node availability information enables the AI orchestrator 122 to distribute workloads to available data nodes 406 and to avoid routing workloads to unavailable nodes. The AI orchestrator 122 uses the virtual datastore 430 abstraction to access data location information without requiring knowledge of physical data placement across the data nodes 406.

With continued reference to FIG. 4, the AI orchestrator 122 provides mechanisms for monitoring and reporting on service level agreement compliance within the distributed data access architecture 400. The AI orchestrator 122 tracks performance of AI agents against defined business objectives and service level agreement thresholds. Performance tracking includes measurement of response times, throughput rates, and error rates for AI agent operations. The AI orchestrator 122 compares measured performance against service level agreement targets to identify compliance status for each AI agent within the deployment system 100.

The AI orchestrator 122 generates compliance reports that allow administrators to track AI agent performance against defined business objectives. Compliance reports include performance metrics, service level agreement adherence status, and trend analysis for AI agent operations over time. Administrators access compliance reports through the dashboard/cockpit 110 within the cloud console 102. The compliance monitoring and reporting capabilities enable administrators to identify AI agents that are not meeting service level agreement targets and to take corrective action to improve performance.

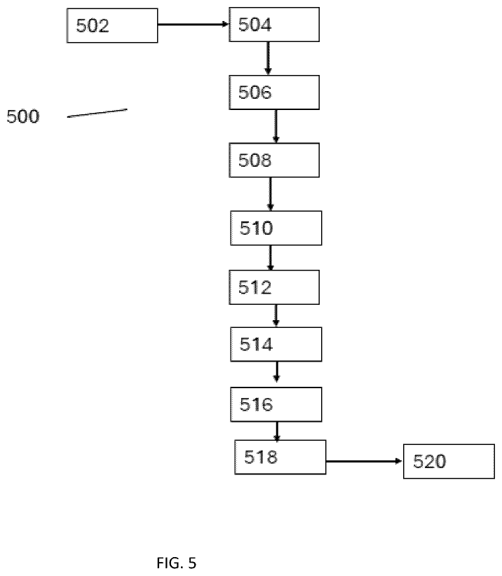

Referring to FIG. 5, a process 500 for application deployment incorporates business SLA-driven orchestration capabilities. At step 514, when a user selects one or more locations to deploy an application, the AI orchestrator 122 evaluates business service level agreement requirements associated with the deployment. The AI orchestrator 122 considers data locality, processing requirements, and network conditions when determining resource allocation for the deployed application. At step 516, the AI orchestrator 122 auto-generates location-specific values and endpoints that align with service level agreement requirements for the selected deployment locations.

With continued reference to FIG. 5, at step 518, the AI orchestrator 122 monitors the progress of each workflow step during deployment and tracks performance metrics against service level agreement targets. The AI orchestrator 122 adjusts resource allocation during deployment based on real-time performance data collected from the deployment workflow. At step 520, when the application is live on the edge location, the AI orchestrator 122 continues to monitor performance and dynamically adjust resources to maintain service level agreement compliance throughout the operational lifecycle of the deployed AI agent.

Referring to FIG. 1, the deployment system 100 facilitates deployment to diverse edge locations including manufacturing floors, healthcare centers, schools, and autonomous vehicles. The edge locations 108 within the deployment system 100 are configured to host AI agents in manufacturing environments where the device controller 134 interfaces with industrial IoT devices, sensors, and production equipment. Manufacturing floor deployments utilize the minimal infrastructure services 136 to support real-time processing of sensor data and quality control operations through the AI agents and workflows 132.

Healthcare center deployments within the deployment system 100 position the edge locations 108 at medical facilities where the device controller 134 connects to medical imaging equipment, patient monitoring devices, and diagnostic instruments through the input/output devices 138. The edge AI apps 130 at healthcare edge locations 108 process medical data locally to support clinical decision-making while maintaining patient data within facility boundaries. School deployments configure the edge locations 108 to support educational AI applications where the device controller 134 interfaces with classroom audio and video devices for learning assistance and administrative automation.

With continued reference to FIG. 1, autonomous vehicle deployments position the edge locations 108 within vehicle computing systems where the device controller 134 interfaces with vehicle sensors, cameras, and control systems. The minimal infrastructure services 136 within autonomous vehicle edge locations 108 provide lightweight runtime environments that support real-time AI agent execution for navigation, object detection, and vehicle control operations. The AI agents and workflows 132 process sensor data streams from the input/output devices 138 to generate driving decisions without requiring continuous connectivity to the central management location 106.

The deployment system 100 supports deployment to disconnected data centers suitable for government agencies and organizations with strict data sovereignty requirements. Disconnected datacenter deployments operate the central management location 106 and the edge locations 108 without persistent network connectivity to the cloud console 102. The AI foundational services 124 and the AI core infrastructure services 126 within the central management location 106 function autonomously during disconnected operation periods, processing AI workloads using locally stored models and data.

Referring to FIG. 3, disconnected datacenter deployments utilize the distributed data fabric architecture 300 to maintain data access capabilities during network isolation periods. The controller data nodes 306 and the data nodes 308 within each data node trust zone 310 continue to serve data requests from AI agents operating within the disconnected environment. The data orchestration network 302 routes data requests between the application node 304 and the data nodes 308 within the isolated network boundary without requiring external connectivity.

With continued reference to FIG. 3, government agency deployments configure the data node trust zones 310 to enforce strict data sovereignty boundaries that prevent data from leaving designated geographic or organizational boundaries. A data node 308 within a government deployment stores classified or sensitive data that remains within the data node trust zone 310 throughout all processing operations. The hierarchical structure of the controller data nodes 306 and the data nodes 308 enables enforcement of data sovereignty policies at each level of the distributed data fabric architecture 300.

Referring to FIG. 4, disconnected datacenter deployments utilize the distributed data access architecture 400 to enforce access control policies without connectivity to external identity providers. The local authentication module 408 validates credentials against locally cached identity information when the customer directory services 402 is unreachable. The authorizer 410 enforces Access Control List statements that are propagated to the data nodes 406 prior to disconnection, ensuring consistent access control enforcement during isolated operation.

With continued reference to FIG. 4, the coordinator 416 maintains fabric state and node availability information during disconnected operation through the inter-node advertisements 426. The virtual datastore 430 continues to provide location-agnostic data access for AI agents operating within the disconnected environment. The data access gateway 414 routes data requests 422 to available data nodes 406 based on locally maintained routing information without requiring external coordination.

Referring to FIG. 1, the deployment system 100 allows for hybrid deployments that span multiple environment types, combining edge processing at the edge locations 108 with centralized resources at the central management location 106. Hybrid multi-environment deployments distribute AI agent workloads between the edge locations 108 and the central management location 106 based on processing requirements and data locality considerations. The AI orchestrator 122 coordinates workload distribution across the hybrid deployment, routing compute-intensive tasks to the AI core infrastructure services 126 at the central management location 106 while positioning latency-sensitive processing at the edge locations 108.

Hybrid deployments utilize the AI foundational services 124 at the central management location 106 for model training and knowledge base aggregation while the AI agents and workflows 132 at the edge locations 108 perform inference and real-time data processing. The device controller 134 at each edge location 108 collects data from the input/output devices 138 and transmits aggregated data to the central management location 106 for centralized analytics and model refinement. The bidirectional data flow between the edge locations 108 and the central management location 106 enables hybrid deployments to leverage both distributed edge processing and centralized computational resources.

Referring to FIG. 3, hybrid multi-environment deployments span the distributed data fabric architecture 300 across edge sites and centralized data centers. The data orchestration network 302 connects the application node 304 at edge locations to the controller data nodes 306 at centralized facilities, enabling data access across the hybrid environment. The data node trust zones 310 are configured to span geographic boundaries, with some data nodes 308 positioned at edge locations and other data nodes 308 positioned at centralized data centers within the same trust zone.

With continued reference to FIG. 3, hybrid deployments position time-sensitive applications at data nodes 308 located at edge sites while maintaining knowledge bases and model repositories at data nodes 308 located at centralized facilities. The application node trust zone 312 encompasses application nodes distributed across both edge and centralized locations within the hybrid deployment. The data orchestration network 302 provides consistent data access interfaces across the hybrid environment, enabling AI agents to access data regardless of physical location within the distributed data fabric architecture 300.

Referring to FIG. 5, the process 500 incorporates pre-configured deployment templates for common use cases in different environments to accelerate deployment processes. At a step 502, the system identifies application manifests that include pre-configured templates tailored to specific deployment environments such as manufacturing, healthcare, education, or autonomous vehicle scenarios. The pre-configured templates define default configurations, resource allocations, and integration parameters appropriate for each environment type.

At a step 504, the porting agent discovers dependencies for the application based on the selected pre-configured template. The template-based discovery identifies Helm charts, docker images, and core dependencies that are appropriate for the target deployment environment. Manufacturing templates specify dependencies for industrial protocol support and sensor integration. Healthcare templates specify dependencies for medical device connectivity and health data processing. Education templates specify dependencies for classroom device integration and learning management system connectivity.

With continued reference to FIG. 5, at a step 506, the workflow agent (which is a porting agent that uses workflow engine to create step-by-step action for deployment) generates a deployment workflow based on the pre-configured template selected for the target environment. The template-based workflow generation produces environment-specific deployment steps that account for infrastructure characteristics and integration requirements of each deployment type. At a step 508, the user validates the template-generated workflow and modifies configuration parameters as needed for the specific deployment scenario.

At a step 510, the porting agent creates manifests based on the pre-configured template and stages the application deployment manifests in the application library. The template-based manifest creation produces deployment artifacts that incorporate environment-specific configurations and resource specifications. In many cases these deployment artifacts may include LLM/Deep learning model weights. The model weights can then be applied to the target system depending on the business need.

At a step 512, the user browses available application manifests organized by deployment environment type and selects the appropriate template-based manifest for deployment to available edge locations.

Referring to FIG. 2, pre-configured deployment templates incorporate environment-specific safe context configurations within the AI agent platform 200. Manufacturing templates define the user RBAC scope 204 with roles appropriate for plant operators, maintenance technicians, and production managers. Healthcare templates define the compliance regulatory scope 206 with configurations that enforce health data privacy regulations. Education templates define the scope of intent 208 with initiative configurations appropriate for academic and administrative use cases.

With continued reference to FIG. 2, the pre-configured templates generate the LLM safe context 212 with boundaries appropriate for each deployment environment type. Manufacturing safe contexts restrict AI agent access to production data and equipment control systems. Healthcare safe contexts enforce patient data access restrictions and audit logging requirements. The system prompts 214 generated from template-based safe contexts incorporate environment-specific constraints that govern LLM based agent 216 behavior within each deployment type.

Referring to FIG. 5, the process 500 for application deployment in the deployment system 100 begins at the step 502 where a user provides access to an application manifest deployed in a cloud environment. The application manifest contains configuration information, deployment parameters, and metadata that define the AI application to be deployed across the distributed environment. The user initiates the deployment process by identifying the application manifest within the cloud console 102, enabling the deployment system 100 to access the manifest contents for subsequent processing steps.

At the step 504, a dependency discovery agent discovers dependencies for the application based on the application manifest identified at the step 502. The dependency discovery agent identifies Helm charts that define the application's container orchestration requirements and deployment configurations. The dependency discovery agent locates docker images that contain the application code and runtime environments required for execution at the edge locations 108. The dependency discovery agent also identifies additional core dependencies including libraries, frameworks, and supporting services that the application requires for operation. The dependency discovery agent generates a comprehensive list of all required dependencies based on application configurations and values specified within the application manifest.

At the step 506, a workflow agent generates a deployment workflow for the application based on the discovered dependencies and the target deployment environment. The workflow agent creates a sequence of deployment steps with associated actions that define the order of operations for deploying the application to the selected edge locations 108. The deployment workflow incorporates the Helm charts, docker images, and core dependencies identified at the step 504 into a structured execution plan. The workflow agent presents the generated deployment workflow to the user for review and validation.

With continued reference to FIG. 5, at the step 508, the user validates the deployment workflow generated at the step 506. The user reviews the sequence of deployment steps and associated actions within the workflow to confirm that the workflow accurately reflects the intended deployment configuration. The user adds missing fields to the workflow where the workflow agent was unable to determine configuration values from the application manifest. The user updates configurations within the workflow to align with specific requirements of the target deployment environment. Upon completing the review and modifications, the user approves the workflow to proceed with deployment preparation.

The deployment system 100 performs pre-deployment validation checks prior to executing the approved workflow. The pre-deployment validation checks verify whether appropriate data controls are enabled for the application to operate at the target edge node within the edge locations 108. The data control verification confirms that Access Control List statements within the distributed data access architecture 400 authorize the application to access required data resources at the target deployment location. If data controls are not enabled for the application at the target edge node, the deployment system 100 informs the user that the data control configuration requires correction before deployment proceeds. The user receives notification identifying the specific data control configurations that require enablement for the application to function at the target edge location 108.

As shown further in FIG. 5, the pre-deployment validation checks also verify whether appropriate resources exist at the target edge node to support application execution. Resource verification confirms that the target edge location 108 possesses sufficient computing capacity, memory allocation, storage space, and network bandwidth to execute the application according to the deployment workflow specifications. If there is a lack of resources at the target edge node, the deployment system 100 indicates to the user what resources are needed for the deployment operation to succeed. The resource requirement notification specifies the computing, memory, storage, and network resources that the target edge location 108 lacks relative to the application requirements defined in the deployment workflow.

The pre-deployment validation checks evaluate the minimal infrastructure services 136 at the target edge location 108 to confirm compatibility with the application runtime requirements. The validation process compares the application dependencies discovered at the step 504 against the capabilities available within the minimal infrastructure services 136. The deployment system 100 generates a validation report that identifies any gaps between application requirements and available infrastructure capabilities at the target deployment location.

With continued reference to FIG. 5, at the step 510, a porting agent creates manifests required to deploy the application and stages the application deployment manifests for subsequent use. The porting agent transforms the validated deployment workflow from the step 508 into deployment manifests that contain executable deployment instructions for the target edge locations 108. The deployment manifests incorporate the Helm charts, docker images, and core dependencies discovered at the step 504 into structured deployment artifacts. The porting agent stages the created manifests in an application library accessible through a portal user interface within the cloud console 102. The staged manifests reside in the application library where users browse and select manifests for deployment to available edge locations 108 within the deployment system 100.

At the step 512, users browse available application manifests within the application library to identify manifests for deployment on available system runtimes. The portal user interface displays the staged manifests with associated metadata including application name, version, resource requirements, and compatible deployment environments. Users navigate the application library to locate manifests that correspond to applications intended for deployment at specific edge locations 108. The browsing interface presents manifest details that enable users to evaluate compatibility between application requirements and available infrastructure at target deployment locations.

As further shown in FIG. 5, at the step 514, the user selects one or more locations to deploy the application from the staged manifest. The location selection interface presents available edge locations 108 within the deployment system 100 that possess infrastructure capabilities compatible with the selected application manifest. Users designate target deployment locations by selecting from the presented edge locations 108, with the selection interface supporting single-location or multi-location deployment configurations. The location selection at the step 514 defines the deployment targets for the subsequent deployment execution steps.

At the step 516, the porting agent auto-generates location-specific values and endpoints for each selected deployment location. The auto-generation process produces configuration values that are tailored to the infrastructure characteristics, network topology, and resource availability at each target edge location 108. The porting agent generates endpoint configurations that establish communication pathways between the deployed application and data services within the distributed data fabric architecture 300. Location-specific value generation accounts for differences in available resources, network addresses, and service endpoints between deployment locations. The auto-generated values ensure proper configuration for each deployment environment without requiring manual configuration entry by users for each target location.

The deployment system 100 triggers application deployment following the auto-generation of location-specific values at the step 516. The deployment execution transfers the application manifests and associated metadata from the cloud console 102 to the target edge locations 108. The deployment system 100 shuts down any existing instance of the application on the cloud environment prior to initiating the edge deployment. The deployment system 100 procures the metadata associated with the application from the cloud environment and transfers the metadata to the target edge location 108. The metadata transfer includes configuration parameters, state information, and operational data that enable the application to resume operation at the edge location 108.

With continued reference to FIG. 5, at the step 518, the user interface shows the progress of each workflow step during the deployment execution. The progress display indicates the status of manifest transfer, dependency installation, configuration application, and service initialization operations at each target edge location 108. The user interface updates the progress display as each workflow step completes, providing visibility into the deployment execution across all selected deployment locations. The progress display indicates a done status when the deployment workflow completes all steps for a target edge location 108.

At the step 520, the application is live on the edge location 108 following completion of the deployment workflow. The deployment system 100 instantiates the application on the edge node using the transferred metadata and the auto-generated location-specific configuration values. The instantiation process initializes the application runtime environment within the minimal infrastructure services 136 at the target edge location 108. The instantiated application connects to data services through the data access gateway 414 within the distributed data access architecture 400 using the auto-generated endpoint configurations. The live application at the edge location 108 operates using the transferred metadata and configuration, enabling the application to function with state and settings that correspond to the prior cloud deployment.

Referring to FIG. 1, the deployment system 100 incorporates a workflow suggestion system that addresses business problems by generating workflow recommendations based on user-described challenges. The workflow suggestion system operates within the AI foundational services 124 at the central management location 106 and processes natural language inputs from business users describing specific operational challenges. The workflow suggestion system analyzes the described business problem and generates workflow recommendations that integrate data sources from the input/output devices 138 at the edge locations 108 with processing capabilities provided by the AI agents and workflows 132.

The workflow suggestion system presents users with multiple workflow options that represent different resource and complexity tradeoffs for addressing the described business problem. The workflow suggestion system generates three tiers of workflow options: a low-cost option, an optimal option, and a fine-fit option. The low-cost option prioritizes minimal resource usage and implementation complexity, utilizing existing infrastructure capabilities within the minimal infrastructure services 136 at the edge locations 108 without requiring additional resource provisioning. The low-cost workflow option reduces computational overhead and network bandwidth consumption by limiting processing steps and data transfers between the edge locations 108 and the central management location 106.

With continued reference to FIG. 1, the optimal option balances resource requirements and performance to provide a workflow solution that achieves acceptable performance levels while maintaining reasonable resource consumption. The optimal workflow option distributes processing tasks between the edge locations 108 and the central management location 106 based on data locality and computational requirements. The optimal option leverages the AI core infrastructure services 126 for compute-intensive operations while positioning latency-sensitive processing at the edge locations 108 proximate to the input/output devices 138 that generate source data.

The fine-fit option provides a customized workflow tailored to the specific requirements of the organization, incorporating specialized components and configurations that address unique aspects of the described business problem. The fine-fit workflow option utilizes additional resources within the AI foundational services 124 and the AI core infrastructure services 126 to deliver enhanced performance, accuracy, or functionality compared to the low-cost and optimal options. The fine-fit option includes specialized AI agents within the AI agents and workflows 132 that are configured for the specific business domain and operational context described by the user.

Referring to FIG. 2, the workflow suggestion system generates workflow options that operate within the boundaries defined by the LLM safe context 212. Each workflow option incorporates constraints derived from the user RBAC scope 204, the compliance regulatory scope 206, the scope of intent 208, and the entities knowledge graphs 210. The workflow suggestion system ensures that all three tiers of workflow options comply with access control and regulatory requirements established by the customer admin 202. The low-cost, optimal, and fine-fit workflow options, each respect the boundaries of the LLM safe context 212 while differing in resource allocation and processing complexity.

With continued reference to FIG. 2, the workflow suggestion system provides details on components required for implementation of each workflow option. Component details include specifications for IoT devices, mobile applications, video cameras, document readers, and other data collection or processing tools that integrate with the device controller 134 at the edge locations 108. The workflow suggestion system outlines manual intervention points required within each workflow option, identifying steps where human review or approval is incorporated into the automated processing sequence.

The workflow suggestion system provides a graphical user interface through which users view suggested workflows and examine workflow details. The graphical user interface displays the three tiers of workflow options with associated resource requirements, estimated performance characteristics, and implementation complexity indicators. Users navigate the graphical user interface to compare the low-cost, optimal, and fine-fit options and examine the processing steps, data flows, and component requirements for each workflow tier. The graphical user interface presents workflow visualizations that depict the sequence of operations, data transformations, and decision points within each suggested workflow.

Referring to FIG. 3, the workflow suggestion system provides programmatic access to workflow details through application programming interfaces. The application programming interfaces enable integration of workflow suggestion capabilities with existing business systems and automation tools. External systems invoke the application programming interfaces to retrieve workflow recommendations, examine workflow specifications, and initiate workflow deployment operations. The application programming interfaces return workflow details in structured data formats that enable programmatic parsing and processing by client applications.

With continued reference to FIG. 3, the application programming interfaces expose workflow component specifications including data access requirements within the distributed data fabric architecture 300. Workflow specifications retrieved through the application programming interfaces identify data nodes 308 that store data required for workflow execution and specify data access patterns across the data orchestration network 302. The programmatic interface enables automated systems to evaluate workflow data requirements against available data resources within the data node trust zones 310 prior to workflow deployment.

Referring to FIG. 4, the workflow suggestion system enables users to edit workflows by adding manual intervention steps at designated points within the automated processing sequence. Users configure manual intervention steps through the graphical user interface by selecting workflow positions where human review, approval, or input is required. The manual intervention configuration specifies criteria that trigger the intervention step, defining conditions under which the workflow pauses for human involvement. Intervention criteria include data quality thresholds, confidence score minimums, exception conditions, and business rule triggers that determine when automated processing yields to human decision-making.

With continued reference to FIG. 4, users configure notification mechanisms for manual intervention steps that alert designated personnel when intervention is required. Notification configuration specifies communication channels, recipient lists, and escalation procedures for intervention alerts. The manual intervention steps integrate with the apps/agents 412 within the distributed data access architecture 400, enabling intervention notifications to reach appropriate personnel through configured messaging platforms. Users define timeout periods for manual intervention steps that specify maximum wait durations before the workflow proceeds with default actions or escalates to alternative reviewers.

Referring to FIG. 5, the workflow suggestion system offers a validation process for modified workflows that ensures compatibility with platform capabilities and organization requirements. The validation process evaluates user modifications to suggested workflows against the infrastructure capabilities available within the deployment system 100. Validation checks confirm that modified workflows utilize components and services that exist within the AI foundational services 124 and the AI core infrastructure services 126 at the central management location 106. The validation process verifies that data access requirements specified in modified workflows align with Access Control List statements configured within the distributed data access architecture 400.

With continued reference to FIG. 5, the validation process evaluates resource requirements of modified workflows against available capacity at target deployment locations. Resource validation confirms that the edge locations 108 possess sufficient computing, memory, and storage resources to execute the modified workflow according to specified performance requirements. The validation process identifies conflicts between workflow modifications and platform constraints, generating validation reports that specify incompatibilities requiring resolution before workflow deployment proceeds.

The validation process evaluates manual intervention configurations within modified workflows to confirm that intervention steps integrate properly with platform notification and communication services. Intervention validation verifies that configured notification channels exist and that designated intervention recipients possess appropriate authorization to perform the specified intervention actions. The validation process confirms that intervention timeout configurations fall within acceptable ranges and that default actions specified for timeout conditions comply with organizational policies and regulatory requirements.

As shown further in FIG. 5, the validation process generates a validation report upon completion of all validation checks. The validation report identifies validation status for each aspect of the modified workflow including component compatibility, resource availability, data access authorization, and intervention configuration. The validation report specifies any validation failures with detailed descriptions of the incompatibilities detected and recommendations for resolving the identified issues. Users review the validation report through the graphical user interface and modify workflow configurations to address validation failures before resubmitting the workflow for validation.

The workflow suggestion system stores validated workflows in a workflow catalog accessible through the graphical user interface and the application programming interfaces. The workflow catalog organizes validated workflows by business domain, deployment environment, and resource tier to facilitate workflow discovery and reuse. Users browse the workflow catalog to identify pre-validated workflows that address business problems similar to their current requirements. The workflow catalog enables organizations to build libraries of validated workflow solutions that accelerate deployment of AI-driven automation for recurring business challenges.

Referring to FIG. 1, the deployment system 100 incorporates an auto-generated monitoring system that produces monitoring profiles for applications, platform components, and infrastructure elements across the distributed environment. The auto-generated monitoring system operates within the AI foundational services 124 at the central management location 106 and collects data from the edge locations 108 to generate monitoring configurations. The monitoring profile generation process analyzes customer intent for deployed applications as expressed through configuration parameters and deployment specifications within the AI apps database 120. The auto-generated monitoring system examines application specifications including resource requirements, performance targets, and operational constraints defined within deployment manifests to determine appropriate monitoring parameters.

The auto-generated monitoring system collects resource usage metrics from the AI core infrastructure services 126 at the central management location 106 and from the minimal infrastructure services 136 at each edge location 108. Resource usage metrics include CPU utilization, memory consumption, storage throughput, network bandwidth usage, and GPU utilization for AI workloads. The monitoring system also collects infrastructure performance data including response latencies, error rates, queue depths, and service availability measurements across the deployment system 100. The combination of customer intent, application specifications, resource usage metrics, and infrastructure performance data provides the input data that the auto-generated monitoring system uses to produce monitoring profiles tailored to each deployed application and infrastructure component.

With continued reference to FIG. 1, the auto-generated monitoring profiles define rules and thresholds for alerting operational users, application developers, and customers about anomalies and performance issues. Each monitoring profile specifies metric collection intervals, threshold values for alert generation, alert severity classifications, and notification routing configurations. The AI orchestrator 122 uses the auto-generated monitoring profiles to track performance of AI agents within the AI agents and workflows 132 at the edge locations 108. The dashboard/cockpit 110 within the cloud console 102 displays monitoring data and alerts generated according to the auto-generated monitoring profiles, enabling administrators to observe system health across the deployment system 100.

The deployment system 100 employs adaptive learning techniques to refine and adjust monitoring profiles over time based on historical data and observed patterns. The adaptive learning process operates within the AI foundational services 124 and analyzes historical monitoring data collected from the central management location 106 and the edge locations 108. The adaptive learning process identifies patterns in metric values, alert frequencies, and operational responses that inform adjustments to monitoring profile configurations. Historical data analysis includes examination of metric trends, seasonal variations, workload patterns, and correlation between different metrics across the deployment system 100.

As further shown in FIG. 1, the adaptive learning process analyzes the effectiveness of existing monitoring rules and thresholds within each monitoring profile. Effectiveness analysis evaluates the frequency of alerts generated by each monitoring rule over defined time periods. The adaptive learning process calculates alert accuracy by comparing generated alerts against confirmed operational issues that required intervention. Alert accuracy measurement identifies monitoring rules that generate false positive alerts where no actual issue exists and false negative situations where issues occur without corresponding alerts. The adaptive learning process uses frequency and accuracy analysis to identify monitoring rules that require threshold adjustment or rule modification.

The adaptive learning process automatically adjusts alert thresholds based on the frequency and accuracy analysis results. Threshold adjustment increases alert thresholds for monitoring rules that generate excessive false positive alerts, reducing alert noise while maintaining detection of genuine issues. Threshold adjustment decreases alert thresholds for monitoring rules that fail to detect confirmed issues, improving detection sensitivity for conditions that require operational attention. The adaptive learning process modifies monitoring rules by adding or removing conditions, adjusting time windows for metric evaluation, and updating severity classifications based on observed operational impact of detected conditions.

Referring to FIG. 2, the deployment system 100 provides mechanisms for operational users, application developers, and customers to provide feedback on monitoring alerts through natural language inputs. The feedback mechanism operates through the AI agent platform 200 where users submit natural language descriptions of alert relevance, accuracy, and operational impact. Users provide feedback indicating whether alerts accurately identified issues requiring attention or whether alerts represented false positives that did not correspond to actual problems. The LLM based agent 216 processes the natural language feedback inputs and extracts structured information about alert quality and operational relevance.

With continued reference to FIG. 2, the natural language feedback mechanism enables users to describe the context and circumstances surrounding alert generation without requiring technical specification of monitoring parameters. Users describe operational conditions, workload characteristics, and environmental factors that influenced alert relevance through conversational inputs processed by the LLM based agent 216. The system prompts 214 guide the feedback collection process by requesting specific information about alert accuracy, response actions taken, and suggestions for monitoring improvement. The grounded and secure response 218 confirms receipt of feedback and summarizes the extracted information for user verification before incorporating the feedback into the adaptive learning process.

The adaptive learning process incorporates the natural language feedback into monitoring profile refinement operations. Feedback indicating false positive alerts triggers threshold adjustment analysis for the corresponding monitoring rules. Feedback indicating missed issues triggers sensitivity analysis to identify threshold reductions or additional monitoring rules that would detect similar conditions. The adaptive learning process aggregates feedback across multiple users and alert instances to identify systematic patterns that inform monitoring profile modifications. Aggregated feedback analysis prevents individual feedback instances from causing excessive monitoring profile changes while enabling consistent feedback patterns to drive meaningful improvements.

Referring to FIG. 3, the deployment system 100 analyzes operational costs associated with responding to different types of alerts and adjusts monitoring thresholds accordingly to optimize resource utilization. Cost analysis examines the operational effort required to investigate and respond to alerts generated by each monitoring rule within the distributed data fabric architecture 300. The cost analysis process tracks time spent by operational personnel investigating alerts, resources consumed during alert response activities, and business impact of delayed response to genuine issues. Cost metrics include personnel hours, computing resources allocated for diagnostic operations, and opportunity costs associated with operational attention diverted from other activities.

With continued reference to FIG. 3, the cost-aware threshold adjustment process balances alert sensitivity against operational cost implications. Monitoring rules that generate alerts with high investigation costs and low confirmation rates receive threshold adjustments that reduce alert frequency while maintaining detection of high-impact conditions. The cost analysis process evaluates the relative costs of false positive alerts versus missed detections for each monitoring rule. Monitoring rules where missed detection costs exceed false positive investigation costs receive threshold adjustments that increase sensitivity despite higher alert volumes. The cost-aware adjustment process optimizes the overall operational cost profile of the monitoring system across the data orchestration network 302 and the data nodes 308 within each data node trust zone 310.

The cost analysis process considers the deployment location when evaluating operational costs for alert response. Alerts generated at the edge locations 108 incur different response costs compared to alerts generated at the central management location 106 due to differences in personnel availability, network connectivity, and physical access requirements. The cost-aware threshold adjustment process applies location-specific cost factors when calculating optimal threshold values for monitoring rules deployed across the distributed data fabric architecture 300. Remote edge deployments with limited on-site support receive threshold adjustments that reduce low-priority alert volumes while maintaining sensitivity for conditions that require immediate attention.

Referring to FIG. 4, the auto-generated monitoring profiles are tailored to specific application types and deployment environments within the distributed data access architecture 400. The monitoring profile generation process produces different profiles for edge deployments compared to cloud-based deployments based on the distinct operational characteristics of each environment type. Edge deployment monitoring profiles account for resource constraints within the minimal infrastructure services 136, network connectivity limitations, and local processing requirements at the edge locations 108. Cloud-based deployment monitoring profiles account for elastic resource availability, centralized management capabilities, and integration with cloud provider monitoring services.

With continued reference to FIG. 4, edge deployment monitoring profiles specify metric collection configurations that minimize resource consumption on constrained edge hardware. Edge profiles define longer collection intervals for non-critical metrics and prioritize collection of metrics that indicate conditions requiring immediate local response. Edge deployment monitoring profiles include offline operation modes that continue monitoring and local alerting when connectivity to the coordinator 416 is unavailable. The edge monitoring profiles store alert data locally within the datastore 418 at each data node 406 during connectivity interruptions and synchronize accumulated alerts when connectivity is restored.

Cloud-based deployment monitoring profiles leverage the centralized infrastructure capabilities available within the customer VPC/datacenter 104. Cloud profiles specify shorter metric collection intervals and more comprehensive metric coverage compared to edge profiles. Cloud deployment monitoring profiles integrate with the data access gateway 414 to monitor data access patterns, authorization events, and data transfer volumes across the virtual datastore 430. The cloud monitoring profiles utilize the apps/agents 412 to perform complex metric aggregation and correlation analysis that would exceed the processing capabilities available at resource-constrained edge locations 108.

The monitoring profile generation process produces environment-specific profiles for specialized deployment scenarios including manufacturing, healthcare, and autonomous vehicle environments. Manufacturing deployment monitoring profiles include metrics specific to industrial equipment integration through the device controller 134 and production process monitoring. Healthcare deployment monitoring profiles include metrics related to medical device connectivity, patient data access patterns, and regulatory compliance indicators. Autonomous vehicle deployment monitoring profiles include metrics for sensor data processing latency, decision-making response times, and safety system status monitoring.

Referring to FIG. 1, the deployment system 100 provides visualization tools and dashboards through the dashboard/cockpit 110 within the cloud console 102 to help users understand performance of AI deployments and effectiveness of auto-generated monitoring profiles. The visualization dashboards display real-time and historical performance metrics collected from the central management location 106 and the edge locations 108. Dashboard visualizations include time-series charts showing metric trends, heat maps indicating resource utilization across deployment locations, and status indicators showing current health of monitored components.

With continued reference to FIG. 1, the monitoring visualization dashboards display alert statistics that indicate the effectiveness of auto-generated monitoring profiles. Alert statistics include alert counts by severity level, alert frequency trends over time, and alert resolution metrics showing time to acknowledge and resolve generated alerts. The dashboards display false positive rates calculated by the adaptive learning process, enabling administrators to assess monitoring profile accuracy and identify rules requiring adjustment. Alert correlation visualizations show relationships between alerts generated across different components and locations within the deployment system 100.

The visualization dashboards provide drill-down capabilities that enable users to examine detailed monitoring data for specific applications, infrastructure components, or deployment locations. Users navigate from summary views showing aggregate metrics across the deployment system 100 to detailed views showing individual metric values and alert histories for selected components. The drill-down navigation enables administrators to investigate performance issues by examining the specific metrics and alerts associated with affected components within the AI foundational services 124, the AI core infrastructure services 126, or the edge locations 108.

Referring to FIG. 5, the visualization dashboards integrate with the process 500 for application deployment to display monitoring profile status for deployed applications. At the step 520 when an application is live on the edge location 108, the visualization dashboard displays the auto-generated monitoring profile associated with the deployed application. The dashboard shows the monitoring rules, threshold values, and alert configurations that the monitoring system generated based on the application specifications and deployment environment characteristics. Users review the auto-generated monitoring profile through the visualization dashboard and observe how the adaptive learning process modifies the profile over time based on operational data and feedback.

With continued reference to FIG. 5, the visualization dashboards display adaptive learning metrics that indicate how monitoring profiles evolve through the refinement process. Adaptive learning metrics include threshold adjustment history showing changes to alert thresholds over time, rule modification logs documenting additions and removals of monitoring conditions, and feedback incorporation statistics showing how user feedback influences profile adjustments. The dashboards display comparison views that show monitoring profile configurations before and after adaptive learning adjustments, enabling administrators to understand the impact of the refinement process on monitoring behavior.

The visualization dashboards provide cost analysis views that display operational cost metrics associated with monitoring and alert response activities. Cost analysis views show personnel time allocated to alert investigation, resource consumption for diagnostic operations, and trend analysis indicating whether cost-aware threshold adjustments are reducing overall operational costs. The cost analysis dashboards enable administrators to evaluate the return on investment from the auto-generated monitoring system by comparing monitoring operational costs against the value of issues detected and resolved through the monitoring process.

The following provides a list of figures and their associated elements within the present disclosure.

FIG. 1 illustrates the deployment system 100 for deploying and operating AI agents across distributed environments. The deployment system 100 includes the cloud console 102, the customer VPC/datacenter 104, the central management location 106, and the edge location 108. The cloud console 102 contains the dashboard/cockpit 110, the billing module 112, and the location and apps module 114. The central management location 106 contains the AI apps database 120, the AI orchestrator 122, the AI foundational services 124, and the AI core infrastructure services 126. The edge location 108 contains the edge AI apps 130, the AI agents and workflows 132, the device controller 134, and the minimal infrastructure services 136. The device controller 134 interfaces with the input/output devices 138.

FIG. 2 illustrates the AI agent platform 200 for generating a safe context for AI agents. The AI agent platform 200 includes the customer admin 202, the user RBAC scope 204, the compliance regulatory scope 206, the scope of intent 208, and the entities knowledge graphs 210. The AI agent platform 200 generates the LLM safe context 212 from the scopes controlled by the customer admin 202. The AI agent platform 200 uses the LLM safe context 212 to generate the system prompts 214. The LLM based agent 216 processes the system prompts 214 to produce the grounded and secure response 218. The human prompts 220 are processed by the LLM based agent 216 in combination with the system prompts 214.

FIG. 3 illustrates the distributed data fabric architecture 300 for data access across multiple deployment locations. The distributed data fabric architecture 300 includes the data orchestration network 302, the application node 304, the controller data node 306, and the data node 308. The distributed data fabric architecture 300 is organized into the data node trust zone 310 and the application node trust zone 312.

FIG. 4 illustrates the distributed data access architecture 400 for enforcing access control policies. The distributed data access architecture 400 includes the customer directory services 402, the authentication link 404, the data node 406, the local authentication module 408, the authorizer 410, the apps/agents 412, the data access gateway 414, the coordinator 416, and the datastore 418. The data node 406 contains the data node components 420. The data requests 422 flow between the coordinator 416 and the data node 406. The data agent 424 facilitates data operations within the data node 406. The inter-node advertisements 426 represent communication pathways between the coordinator 416 and the data node 406. The virtual datastore 430 encompasses the distributed data access architecture 400.

FIG. 5 illustrates the process 500 for application deployment in the deployment system 100. The process 500 includes the step 502 where a user provides access to an application manifest. The step 504 involves discovery of dependencies for the application. The step 506 involves generation of a deployment workflow. The step 508 involves user validation of the deployment workflow. The step 510 involves creation and staging of deployment manifests. The step 512 involves browsing available application manifests. The step 514 involves selection of deployment locations. The step 516 involves auto-generation of location-specific values and endpoints. The step 518 involves display of deployment progress. The step 520 indicates that the application is live on the edge location 108.

The system can further be described as a system comprising:
d. a central management location configured to coordinate AI deployments;
e. a plurality of edge locations connected to the central management location, each edge location configured to host AI agents;
f. a distributed data fabric spanning the central management location and the edge locations, the distributed data fabric providing location-agnostic data access for the AI agents; and
g. an orchestrator configured to manage deployment and operation of the AI agents based on business requirements associated with the edge locations.

The system of the current disclosure, wherein the distributed data fabric comprises a plurality of trust zones, each trust zone containing one or more data nodes.

The system of the current disclosure, wherein each data node comprises a data access gateway configured to authorize data access requests from the AI agents.

The system of the current disclosure, wherein the data access gateway utilizes Access Control List statements to manage and restrict data access, the Access Control List statements comprising:
a. a subject attribute identifying an entity requesting access;
b. include access policies related to Location attributes;
c. a Role attribute defining a set of permissions associated with the Subject; and
d. a Scope attribute specifying a data resource to which the permissions apply.

The system of the current disclosure, wherein the orchestrator is configured to generate a safe context for each AI agent based on user scope and regulatory requirements, the safe context defining boundaries within which the AI agent is authorized to operate.

The system of the current disclosure, wherein the user scope comprises a role-based access control scope indicating a role of a user in the system.

The system of the current disclosure, wherein the orchestrator is configured to dynamically adjust resource allocation for the AI agents based on the safe context and real-time performance data.

The system of the current disclosure, wherein the central management location comprises:
a. an AI apps database configured to store application data and configurations;
b. AI foundational services comprising large language model based agent deployment capabilities; and
c. AI core infrastructure services comprising a data fabric service and GPU management services.

The system of the current disclosure, wherein each edge location comprises:
a. a device controller configured to interface with input and output devices including audio devices, video devices, and IoT devices; and
b. minimal infrastructure services configured to support AI agent execution at the edge location.

The system of the current disclosure, further comprising a cloud console configured to establish a secure connection to the central management location, the cloud console providing infrastructure lifecycle management and application lifecycle management for the central management location and the plurality of edge locations.

A method, comprising:
a. receiving a request to deploy an AI agent;
b. determining a deployment location from a plurality of available locations including edge locations and cloud environments;
c. generating a deployment workflow for the AI agent based on the determined deployment location;
d. validating the deployment workflow; and
e. subject to successful validation, executing the validated deployment workflow to deploy the AI agent at the determined deployment location.

The method of the current disclosure, further comprising generating a safe context for the AI agent based on user scope and regulatory requirements, the safe context defining boundaries within which the AI agent is authorized to operate. The safe context can also mean an up to date complete set of validated/verified information for the AI agent to operate. It is not only providing the boundaries of AI agent operation, but also providing rich validated context.

The method of the current disclosure, further comprising configuring the AI agent to operate within the boundaries defined by the safe context, wherein the safe context includes permissions for accessing specific datasets within a distributed data fabric.

The method of the current disclosure, wherein the distributed data fabric spans multiple trust zones, each trust zone containing one or more data nodes, the method further comprising:
a. receiving a data access request from the deployed AI agent;
b. routing the data access request through a data access gateway; and
c. authorizing the data access request based on Access Control List statements associated with the AI agent.

The method of the current disclosure, wherein authorizing the data access request comprises:
a. verifying that the requested data access falls within the boundaries defined by the safe context; and
b. granting access only if the verification is successful.

The method of the current disclosure, wherein validating the deployment workflow comprises:
a. verifying whether data controls are enabled for the AI agent to operate at the determined deployment location; and
b. verifying whether appropriate resources exist at the determined deployment location to support execution of the AI agent.

A non-transitory computer-readable medium storing instructions that, when executed by a processor, cause the processor to perform operations comprising:
a. receiving a data access request from an AI agent deployed across a distributed environment;
b. determining a safe context for the AI agent based on user scope and regulatory requirements, the safe context defining boundaries within which the AI agent is authorized to operate;
c. validating the data access request against access control rules within the determined safe context; and
d. subject to successful validation, providing the AI agent with access to requested data through a distributed data fabric spanning multiple deployment locations.

The non-transitory computer-readable medium of the current disclosure, wherein the distributed data fabric comprises a plurality of trust zones, each trust zone containing one or more data nodes, and wherein each data node comprises a data access gateway configured to authorize data access requests from the AI agent.

The non-transitory computer-readable medium of the current disclosure, wherein validating the data access request comprises verifying that the requested data access falls within the boundaries defined by the safe context and granting access only if the verification is successful.

The non-transitory computer-readable medium of the current disclosure, wherein the operations further comprise:
a. monitoring performance metrics of the AI agent;
b. dynamically adjusting resource allocation for the AI agent based on the monitored performance metrics and the safe context; and
c. generating a deployment workflow for the AI agent based on a determined deployment location.

Referring now to the drawings FIGS. 1-6, and more particularly to FIG. 1, there is shown a system diagram of a deployment system for deploying and operating AI agents across distributed environments, according to aspects of the present disclosure. FIG. 1 shows the Deployment system 100 comprised of:

Cloud Console 102, Dashboard/Cockpit 110, Billing 112, Location and Applications 114, Cloud Portal (Service providers VPC) 140, Command/Control Channel (Deployment commands) 150, Customer VPC/Datacenter 104, AI Hub 106, Central Management Location 105, AI Applications central database 120, AI Orchestrator 122, AI Foundational Services (Pipelines, Large language models, Graph, Structured Query Language (SQL) 124, AL Core Infrastructure Services (Data Fabric, GPU, AI Hub) 126, Customer's Edge Location A 108, AI Applications 130, AI Agents and workflows 132, Device controller 134, Minimal Infra Services 136, Output (Adio, Text, Video, Internet of things) 138 and Data/API request 155.

The central management location of AI hub 106 may represent a physical location with a physical/postal address. The AI hub 106 may be deployed in such a central location and used to manage other edge locations 108 that are within the same premise and/or may somewhat distance apart (e.g., distance <10 km).

The hub-and-spoke architecture may allow for efficient distribution of AI processing capabilities. In some cases, the AI Hub 106 may handle more complex or resource-intensive tasks, while the edge locations (spokes) 108 may perform local processing and data collection. This distribution of tasks may help optimize resource utilization and reduce latency for time-sensitive applications.

The system architecture 100 may also facilitate seamless communication between the Cloud Console 102, AI Hub 106, and edge locations 108. The Command/Control and Deployment interfaces connecting the Cloud Console 102 to the AI Hub 106 may enable administrators to manage and monitor the entire distributed AI deployment from a centralized location. Meanwhile, the Data/AI Requests pathways between the AI Hub 106 and edge locations 108 may allow for efficient data exchange and coordination of AI tasks across the network 100.

By implementing this hub-and-spoke architecture, the unified platform may provide a scalable and flexible solution for deploying AI agents and applications across diverse environments. The architecture may allow organizations to leverage the benefits of edge computing while maintaining centralized control and management of their AI deployments.

Hub-spoke architecture may allow the deployment of apps and agents to be dispersed based on resource needs. A Hub can have multiple registered spokes. The applications can be deployed either at Hub or at individual spokes depending on the nature of the apps (IoT apps, foundation models, knowledgebase). Building this way, every edge location (represented as spoke) need not have huge compute and storage requirements. For instance, take an example of a server with Jetson Orin processor with minimal storage that can be configured as a spoke. Hub services can be deployed on a reasonably powered bunch of enterprise grade servers to host services and data that can be consumed by all registered/connected spokes. A hub can be hosted in a customer datacenter. Enterprise could have multiple hubs with each having multiple connected spokes depending on the network latency and throughput between sites and the datacenters.

Hub and Spoke processes may be deployed on the same host/server to support enterprises with simpler needs. This helps in offering a simpler topology for those who do not have the need to segment their industrial space further. For such an enterprise all data would reside in a lakehouse hosted from a single hub instance. For enterprises where more complex topology is required due to the nature of the domain (industry, shop floors etc.) one or more spoke instances could be deployed connected to a single hub. For instance, take an example of a manufacturing industry, with multiple floors and each floor equipped with 25 cameras, 50 temperature sensors connected via a 5G network to a spoke deployment at every floor.

A hub deployment may include following AI foundational services: Fine-tuned foundation models, Knowledge base with vectorized/machine readable data aggregated from multiple edge locations, AI Agents, Datafabric, & AI apps.

A trust context may be established amongst the hub and all its registered spokes. Access control features may allow Admins to apply strict controls to configure agent permissions to access data using data-fabric APIs. The hub-spoke model de-centralizes the deployment model and helps by distributing AI agents, apps across hubs and spokes. Moving agents & apps closer to data where it is produced is desired.

To provide a general context, the Edge deployments may feature LLM-based Agents. These AI Agents could use ReAct technique to Reason and Act based on users input like any typical AI Agents in the AI community. The user may interact with AI agents using Prompts provided by an Assistant App running on an appropriate console. The AI agent may follow the following steps before a reasonable response is sent back to the user, which is shown in the Prompt pane in the assistant App: Break the Query into multiple sub-queries. For each sub-query, the agent uses its cognitive ability to map the queries to the best of the toolset available to garner more context to reason better. In this process, Agents might invoke a RAG (Retrieval Augmented Pipeline) or an API query to reason better and generate responses that are grounded. The response is then sent back to the user and is shown in the Assistant App.

Enhancements to improve response accuracy to the queries could allow generation of additional contexts carefully bounded by various attributes. These contexts can be beneficial to help keep a response grounded and ensure the Agents do not accept/dig into information that is not Authorized for agents in the safe context.

FIG. 2 is a schematic diagram of an AI agent platform configured to generate a safe context for AI LLM agents, according to an embodiment. FIG. 2 illustrates one example of a safe context scheme that could be employed in an AI agent platform 200 to generate a safe context for the AI LLM Agents to operate.

FIG. 2 shows the AI agent platform 200, Customer Administration 202, User's Role-Based Access Control (RBAC) scope 204, Compliance/regulation scope 206, Scope of intent/goal 208, Scope criteria include entities, knowledge graphs, relations, personal data, etc. 210, LLM Safe Context 212, System prom 214, LLM-based agent 216, Grounded and Secure response 218, Human prompts 220 and how the User 222 interacts with the process.

As shown in FIG. 2 the customer-admin 202 may control a number of scopes that may be relevant to a particular AI agent operation, a particular user, a particular location, or other details of an operation to be performed at a particular edge. An administrator typically has control on defining these individual scopes via an appropriate UI. The scopes translate into context. A context is an entity defining the constraints. These constraints translate into prompts, guard-rails for the LLM based Agents. With this approach, administrators of an enterprise can have peace-of-mind and not worry about wrong data getting in the hands of bad actors.

Examples of typical scopes include a user scope 204, which could be indicative of a particular User's role in the platform for Role-based access control (RBAC) scope 204, an associated scope of compliance/regulation 206 (which may include criteria other than the user), and could also indicate User's intent/goal 208. The UI of the system may have the notion of “Initiative,” in which case a safe context for AI Agents would include the scope of “Initiative” defined in the UI of the system for that user along with User's authorization details.

As noted, the compliance/regulatory scope 206 may have additional criteria beyond the role of the user. For example, the platform might enforce regulatory restrictions to ensure regional data related compliance policies. Such restrictions when applied are applied at overall objects including Users, Data, Processing Step. The AI Agent framework can use such attributes to derive a safe context for the LLM Agents to operate.

Additional scope criteria 210 may include entities, knowledge graphs, relations, personal data, etc.

From the scopes (204-210) considered by the customer admin 202, the platform 200 generates a “Safe Context” 212 for the LLM based agents to execute in. One can imagine the safe context 212 as similar to a “container” or a “namespace” in the world on Linux, where the agents cannot go beyond the bounded context for any execution. The safe context 212 can then be used by the platform 200 when generating system prompts 214 associated with deploying an AI app to a location. The system prompts are processed by an LLM-based agent 216 to provide a grounded and secure response 218 to user queries. The response 218 can then be used in an iterative manner to elicit user human prompts 220, which are processed by the LMM agent 216 in combination with system prompts 214 to refine the response 218.

A customer-admin 202 may have full control on defining the individual scopes (204-210) that translate into the safe context 212. With this approach, administrators of an enterprise can have peace-of-mind and not worry about wrong data getting in the hands of bad actors. Agent deployment may include a single coordinator agent (Controller), 1-to-many purpose-built or Opensource LLM based Agents, and 1-to=many purpose-built or Opensource tools. Requests from users in the AI Assistant app may be handled by the co-ordinator agent. The co-ordinator agent (an LLM based Agent) can generate a safe context for the rest of the query executions and create a query execution plan. This whole process may be performed iteratively, and the co-ordinator agent may execute these queries and break the queries down further until a satisfactory response is arrived at.

The agents deployment framework may feature in-built Agents for accomplishing common tasks, such as SQL Read/Write, reading/co-related JSON objects, Sending Emails, Configuring a notification in Slack and Pagerduty etc. For implementing vertical solutions like Compliance and Safety the AI framework may feature pre-defined workflows and purpose-built LLM based agents. As part of this, the platform may parse the structured output of a document processing module and ingest it into multiple information storage systems. Data ingestion involves extracting structured information from processed documents and transforming it into formats suitable for each storage system. In the SQL database, data is organized into well-defined tables and schemas for efficient querying and analytics. In the knowledge graph, entities and their relationships are dynamically generated, with duplicate entities unified using unique signatures. This dual storage strategy combines the strengths of relational databases and semantic graph structures. LLM-based AI agents access the stored data, leveraging the SQL database for precise, tabular queries and the knowledge graph for semantic reasoning and relationship exploration. These agents answer complex questions, identify patterns, and provide actionable insights by integrating structured data with contextual understanding.

The unified platform may incorporate a distributed data fabric architecture, such as the example shown in FIG. 3, to enable seamless data access and management across multiple edge locations and cloud environments. This architecture may be designed to provide secure and efficient data access across distributed environments.

FIG. 3 illustrates a distributed data fabric architecture configured to enable data access across multiple deployment locations, according to aspects of the present disclosure. FIG. 3 shows the Distributed data fabric architecture 300, Data orchestration network 302, Application node 304, Controller data nodes 306, Associated data nodes 308, Data node trust zone 310, application node trust zone 312, Trust Zone 1/Customer Region 320, Trust Zone 2 325, Trust zone 3 328, Cross-site data fabric 330, S3 332, NFS 334 and POSIX 336.

Furthermore, as one reviews FIG. 3 which depicts a distributed data fabric architecture 300 where a data orchestration network 302 connects together an application node 304 and a number of controller data nodes 306, which in turn can each communicate with one or more data nodes 308. Each controller data node 306 and its associated data nodes 308 reside within a data node trust zone 310, while the application node 304 resides in an application node trust zone 312. The data orchestration network 302 allows communication between the application node 304 and controller data nodes 306, which limits the communications as appropriate for the particular trust zone (310, 312). An Application node 304 may be an additional profile applied to any Node in the system. Typically, a Node could be a Data node (306, 308) participating in data storage and exchange of data (in/out) or exclusively an Application node 304, where only apps are deployed with no or minimum storage. In some schemes, Application node 304 may be an Application-only node that does not participate in data exchanges with other nodes; however, being part of the fabric 300 allows such application nodes 304 to access data from other data nodes (306, 308).

In some cases, the distributed data fabric 300 may employ a hierarchical structure of data nodes. As shown in FIG. 3, Controller Data Node 306 may act as a controller within each data node trust zone 310, connecting to other data nodes 308 within the same zone. This hierarchical arrangement may allow for efficient data management and access control within each trust zone.

The architecture may support various types of data storage and processing components. For example, FIG. 3 illustrates time-sensitive apps connected to Data Nodes (308) 2 and 3 of Trust Zone 1, model deployments, and datasets or collections in a knowledge base. Additionally, the architecture may incorporate raw data, hot, and cache tier storage components to optimize data access and processing performance.

To enable seamless data access across the distributed environment, the architecture may implement a data orchestration layer. This layer, represented by the Data Orchestration API 302 in FIG. 3, may provide interfaces such as SQL, NFS, and POSIX for applications to interact with the distributed data fabric. The data orchestration layer 302 may enable communication across trust zones (310, 312) while maintaining security boundaries, allowing for controlled data access and processing across multiple trust zones (310, 312). In some cases, the distributed data fabric 302 may support a virtual datastore or global namespace for data. This feature may enable location-agnostic data access, allowing AI agents and applications to interact with data without needing to know its physical location. A virtual data-store (such as shown in FIG. 4 as a dashed box), may provide an abstraction layer across the distributed architecture 300.

The architecture 300 may employ various communication paths to facilitate data access and management. As shown in FIG. 3, solid and dashed lines may indicate different types of communication paths between nodes (304, 306, 308). These paths may enable efficient data transfer and coordination between components within and across trust zones (310, 312).

By implementing this distributed data fabric architecture, the unified platform may provide a scalable and flexible solution for managing data across diverse environments. The architecture may allow organizations to maintain data sovereignty and security while enabling seamless access to data for AI agents and applications deployed across edge locations and cloud environments.

The unified platform may incorporate enterprise controls for data serving and access to ensure security and compliance in AI agent interactions and data usage. These controls may allow organizations to specify where their data should be served from and who can access the data.

A unified data fabric that connects across multiple edge locations and cloud may provide seamless access to data to apps, such as enabling app mobility from cloud to on-prem without needing data movement. The AI agents and applications need to access the data they need without needing to know where the data is located as long as the access is authorized. The platform makes access to data seamless by creating a mesh of data nodes. These data nodes can be deployed at an edge site or in a VPC is a customer's cloud. In a mesh, one node acts as the co-ordinator. When a node is down at a location, the co-ordinator is responsible to detect it and repair the paths so that the AI apps and agents from one location continue to work accessing the latest available data. The freshness of the data may be limited to the availability of the target data-node which is the primary holder of that data. Until then, a secondary replica may serve the latest sync'd data to the consumer.

A co-ordinator may be an elected primary node in the fabric that keeps the data connection to data nodes active. It may also send and receive heart-beats from other nodes and/or advertise the status of fabric to clients. Each data node in the fabric may be hosted on an app runtime having an in-built coordinator, data authorizer, and data-gateways components. As part of the boot-process, the node may join the fabric. In cases where no fabric is detected, it could initiate fabric creation and advertise the co-ordinator endpoints inviting other data nodes to join when they become available.

In some cases, the platform may implement a data access control system for AI agents. This system may utilize Access Control List (ACL) statements to manage and restrict data access. Access authorization features can allow control of data access at detailed levels, such as a database table or specific datasets. FIG. 4 illustrates a system diagram of a distributed data access architecture 400 that may support these enterprise controls.

The data access control system may employ ACL statements comprising three main attributes: Subject, Role, and Scope. The Subject attribute may identify the entity requesting access, such as an AI agent, application instance, or user ID. The Role attribute may define a set of permissions associated with the Subject. The Scope attribute may specify the entity or data resource to which the permissions apply.

In some implementations, each AI agent within the platform may be assigned a unique identifier, which may be referred to as the agent service principal. This identifier may be used as the Subject in ACL statements, allowing for granular control over agent access to data resources.

FIG. 4 illustrates a system diagram of a distributed data access architecture, according to an embodiment. FIG. 4 shows the Distributed data access architecture 400,
Customer Directory Services/Customer AD component 402, Data Node coordinator 404,
local-authorization module 408, data access gateway 414, Applications/Agents 412, Coordinator 416, DNC datastore 418, Authorizer 410, Data nodes 406, local collection of applications 424, data access gateway 420, data agent 422, datastore 426, Data Node 428, Virtual Datastore 430, Data-request 432, Authorization 434 and Internode advertisements 436.

Further in FIG. 4 the platform 400 may provide interfaces for customer administrators to manage data access controls. As shown in FIG. 4, a Customer AD component 402 may connect to a Data Node coordinator 404 through an authentication link, and the data node coordinator 404 may in turn communicate to a number of data nodes 406. The Data Node coordinator 404 may contain several components, including a local-auth module 408 and an Authorizer 410, which may work together to enforce access controls. The Data Node coordinator 404 may also include Apps/Agents 412, a data access gateway 414, a coordinator 416, and a DNC datastore 418.

A “Controller” node (such as controller data nodes 306 shown in FIG. 3) may have more responsibilities than a “coordinator” node 404 and such node may have other capabilities, such as (but not necessarily limited to) ensuring state of the entire system (like coordinator), ensuring security policies, retrieving access/activity logs when required etc. The system 400 may allow multiple roles or profiles for nodes. Each node in the system may be able to assume one or more profiles depending on the configuration. Such roles could include, for example, serving as a Data Node, a Data Node Controller (Master), and Data Node Follower, an Application Node, etc. Additional node roles/profiles will evolve as we build the system and adapt to customer use cases. In one scheme, a Controller node ensures the overall state and availability status of all nodes participating in the fabric. The controller (master) is responsible to ensure Data access control list propagation across the fabric to Allow/Deny data access. The coordinator process runs as part of controller (master), to send the membership advertisements to follower nodes.

When an AI agent requests access to a dataset, the request may be routed through the Data Access Gateway 414, as depicted in FIG. 4. The gateway 414 may interface with the Authorizer 410 component to validate the request against the defined ACL statements before granting access or forwarding the request to other data nodes 406.

The data nodes 406 may each have a data access gateway 420, a data agent 422, a local collection of apps 424, and a datastore 426.

The distributed nature of the data access architecture, as illustrated in FIG. 4, may allow for consistent application of access controls across multiple data nodes and trust zones (such as shown in FIG. 3). This approach may enable AI agents to access authorized data without knowing its physical location within the distributed environment, thus creating a virtual datastore 430. The virtual datastore 430 may provide a virtual interface for applications to access data without bothering about the distributed nature of data across multiple data nodes. The virtual datastore 430 may serve as an entity that an application can read and write data to, without knowing how and from where the data is sourced from. The data distribution platform 400 can support app mobility without requiring copy-over of data along with the app across edge nodes.

In some cases, the platform may support fine-grained access control, allowing administrators to restrict access at various levels of granularity, such as database tables or specific datasets. This capability may provide organizations with flexibility in managing data access while maintaining security and compliance requirements.

The enterprise controls for data serving and access may also extend to data movement and replication within the distributed environment. The platform may allow organizations to define policies governing where data can be stored or replicated, ensuring compliance with data sovereignty regulations or internal security policies.

By implementing these enterprise controls for data serving and access, the unified platform may provide organizations with tools to maintain security and compliance in their AI deployments while enabling efficient data access for authorized AI agents and applications.

The unified platform may incorporate a business SLA-driven agent orchestrator to optimize infrastructure resource usage based on business requirements. This orchestrator may enhance efficiency and performance by aligning AI agent operations with specific business needs and service level agreements (SLAs).

In some cases, the agent orchestrator may generate a safe context for LLM-based AI agents to operate within. This safe context may be derived from various factors, including user scope and regulatory requirements.

The user scope may be defined within the platform's user interface and may indicate the user's role and intent or goal. For example, the platform may incorporate the concept of “Initiatives” to represent specific business objectives or projects. The safe context generated for AI agents may include the scope of the relevant Initiative along with the user's authorization details.

Regulatory requirements may also play a role in defining the safe context for LLM-based agents. The platform may enforce regulatory restrictions to ensure compliance with regional data policies. These restrictions may be applied to various objects within the system, including users, data, and processing steps. The agent orchestrator may use these attributes to derive a safe context that aligns with regulatory requirements.

By generating this safe context, the orchestrator may ensure that AI agents operate within predefined boundaries, potentially reducing the risk of unauthorized data access or non-compliant actions. This approach may allow enterprises to have greater control over their AI deployments while maintaining security and compliance.

In some implementations, the business SLA-driven agent orchestrator may use the generated safe context to inform resource allocation decisions. For example, the orchestrator may prioritize resources for AI agents working on high-priority business initiatives or those handling sensitive data subject to strict regulatory requirements.

The orchestrator may also consider performance metrics and SLA requirements when allocating resources. In some cases, the system may dynamically adjust resource allocation based on real-time performance data and changing business priorities. This adaptive approach may help ensure that critical business processes receive the necessary resources to meet SLA requirements.

To further optimize resource usage, the agent orchestrator may implement load balancing techniques across distributed environments. For instance, the orchestrator may distribute AI agent workloads across edge locations and centralized infrastructure based on factors such as data locality, processing requirements, and network conditions. This distribution may help improve overall system efficiency and reduce latency for time-sensitive applications.

The business SLA-driven agent orchestrator may also facilitate the coordination of multiple AI agents working on related tasks. By considering the interdependencies between agents and their respective business objectives, the orchestrator may optimize the sequence and timing of agent operations. This coordination may help reduce resource contention and improve overall system throughput.

In some cases, the agent orchestrator may provide mechanisms for monitoring and reporting on SLA compliance. These features may allow administrators to track the performance of AI agents against defined business objectives and identify areas for optimization. The orchestrator may use this information to refine its resource allocation strategies over time, potentially leading to continuous improvements in efficiency and performance.

By implementing a business SLA-driven agent orchestrator with safe context generation capabilities, the unified platform may provide organizations with a powerful tool for aligning AI operations with business objectives while maintaining security and compliance. This approach may enable more efficient use of infrastructure resources and help ensure that AI deployments deliver value in line with specific business requirements.

The unified platform may enable deployment of AI agents and applications across a diverse range of environments. These environments may include edge locations, customer data centers, co-location facilities, disconnected data centers, and public cloud virtual private clouds (VPCs).

In some cases, the platform may facilitate deployment to edge locations such as manufacturing floors, healthcare centers, schools, or autonomous vehicles. For edge deployments, the platform may optimize resource utilization by distributing AI processing tasks between local edge devices and centralized infrastructure.

The platform may also support deployment to customer data centers. In this scenario, organizations may maintain full control over their hardware and network infrastructure while leveraging the platform's capabilities for AI agent and application management.

Co-location facilities may serve as another potential deployment environment. The platform may enable organizations to deploy AI solutions in shared data center spaces, potentially reducing infrastructure costs while maintaining security and performance.

For scenarios requiring heightened security or isolation, the platform may facilitate deployment to disconnected data centers. These environments may be suitable for government agencies or organizations with strict data sovereignty requirements.

Public cloud VPCs may represent an additional deployment option supported by the platform. In this case, organizations may leverage the scalability and flexibility of public cloud infrastructure while maintaining a level of isolation for their AI workloads.

The platform's deployment capabilities may extend across these diverse environments, potentially enabling organizations to choose the most suitable deployment location based on their specific requirements. In some cases, the platform may allow for hybrid deployments that span multiple environment types, such as combining edge processing with centralized data center resources.

To support seamless deployment across these varied environments, the platform may incorporate standardized deployment processes and abstractions. These features may help minimize environment-specific configurations and reduce the complexity of managing AI solutions across heterogeneous infrastructure.

The platform may also provide mechanisms for environment-specific optimizations. For example, in edge deployments, the platform may automatically adjust resource allocation and processing distribution based on the capabilities of local devices and network conditions.

In some cases, the platform may offer templates or pre-configured deployment patterns tailored to common use cases in different environments. These templates may help accelerate deployment processes and ensure consistent configuration across similar deployment scenarios.

The platform's seamless deployment capabilities may extend to ongoing management and updates of AI agents and applications. This may include features for rolling out updates, scaling resources, and monitoring performance across diverse deployment environments.

By supporting deployment across this range of environments, the platform may enable organizations to implement AI solutions in a manner that aligns with their specific infrastructure requirements, security needs, and operational constraints.

A basic process for deploying AI agents/applications from a cloud to an edge may include the user initiating the movement of the AI agent/application. The distribution platform then checks whether the appropriate data controls are enabled for the application to work in the edge node and checks whether there are appropriate resources at the edge node. If the data controls are not enabled, it can inform the user, and they need to fix that first. If there is a lack of resources, it can indicate what resources are needed for the operation to succeed. If all the checks pass, the platform can shut down the instance on the cloud, procure and transfer the meta-data associated with the app into the edge, and instantiate it on the edge node. The unified platform may provide a one-click move feature that enables the relocation of AI agents and applications across different deployment environments. This feature may allow organizations to easily transfer their AI solutions between various locations, such as from public cloud infrastructure to on-premises data centers or edge environments.

Shutting down the system immediately, many times might be “optional.” To ensure gradual failover, both the instance of the platform may run in an Active/Active configuration for some time until all data/configurations are replicated/mirrored

FIG. 5 is a flowchart depicting a process for application deployment in the deployment system of FIG. 1, according to aspects of the present disclosure. FIG. 5 shows the Flowchart of process 500 comprising:
a. Step 502 User provides access to Application manifest deployed in cloud.
b. Step 504 System Included Porting Agent. discovers the Helm charts. docker images. additional core dependencies for the Application. The agent response. includes all dependencies based on app configurations/values.
c. Step 506 System Included Workflow agent generates a “Workflow for application deployment. It Is presented to the User to validate. A workflow includes a series of step, which Includes actions.
d. Step 508 User validates the workflow, adds missing fields, updates configurations. User then “Approves” the work flow.
e. Step 510 System Included Porting agent creates manifests required to deploy and stages the Application deployment manifests. These manifests. are staged In application library in the portal UI in cloud.
f. Step 512 User browses available application manifests to deploy on any available Edge locations. User selects the location to deploy the Application from staged manifest.
g. Step 514 User selects one or more locations to deploy the application.
h. Step 516 System included Porting agent auto-generates location specific values/endpoints accordingly. The system triggers application deployment.
i. Step 518 UI shows the progress of each workflow step of deployment. User Interface (UI) shows “done” when the deployment Is Completed.
j. Step 520 Application is LIVE on Edge location.

In some cases, the one-click move process may involve several automated steps to ensure a smooth transition of the AI agent or application. FIG. 5 illustrates a flowchart depicting one example of process 500 for application staging and deployment in a system, which may be the one-click move feature once applications have been staged for deployment.

The process 500 may begin with the system identifying the application manifest in the cloud environment (step 502). A porting agent may then discover the necessary dependencies for the application (step 504), including Helm charts, docker images, and additional core dependencies. Based on the application configurations and values, the agent may generate a comprehensive list of all required dependencies in step 504.

Following the discovery phase, the system may generate a workflow for the application deployment (step 506). This workflow may be presented to the user for validation and modification if needed. The user may have the opportunity to add any missing fields, update configurations, and approve the final workflow (step 508).

Once the user approves the workflow in step 508, in the system may create the required manifests for deployment and stage them for use (step 510). These manifests may become available in the user interface, allowing users to browse and select the appropriate manifests for deployment on available system runtimes (step 512).

The user may then select one or more locations to deploy the application (step 514). The system may automatically generate location-specific values and endpoints to ensure proper configuration for each deployment environment (step 516). This step may be particularly useful when moving an AI agent or application from a cloud environment to an edge location, as it may account for differences in available resources and network configurations. After the location selection and configuration, the system may trigger the application deployment.

The user interface may display the progress of the deployment workflow (step 518), indicating when the process is completed. Upon completion, the AI agent or application may be live and operational in the new location (step 520).

The one-click or other simplified move features may provide several benefits to organizations utilizing AI solutions. It may reduce the complexity and time required to relocate AI agents and applications between different environments. This capability may enable organizations to optimize their AI deployments based on changing requirements, such as data locality, latency considerations, or regulatory compliance needs.

In addition to the one-click move feature, the system may offer a one-time migration path for AI solution providers. This feature may allow providers to transition their existing solutions from public cloud providers to the unified platform. The migration process may involve similar steps to the one-click move, but with additional considerations for adapting the solution to the platform's architecture and capabilities.

The one-time migration path may enable AI solution providers to leverage the benefits of the unified platform, such as improved deployment flexibility and enhanced data control, while minimizing the effort required to transition from their current cloud-based implementations. This feature may facilitate the adoption of the platform by a wider range of AI solution providers, potentially expanding the ecosystem of available AI applications and agents for end-users.

The unified platform may incorporate a workflow suggestion and implementation system to address complex business problems. This system may provide organizations with the ability to design, customize, and execute AI-driven workflows that integrate various data sources and devices.

In some cases, the platform may offer an interface for business users to describe their specific business challenges using natural language inputs. Based on these inputs, the system may generate workflow suggestions or recommend pre-existing workflows from a catalog of validated options.

The workflow suggestion system may present users with multiple options, which may include low-cost, optimal, and fine-fit solutions. The low-cost option may prioritize minimal resource usage and implementation complexity. The optimal option may balance resource requirements and performance to provide a well-rounded solution. The fine-fit option may offer a customized workflow tailored to the specific needs of the organization, potentially requiring more resources or specialized components.

When suggesting workflows, the system may provide details on the necessary components for implementation. These components may include IoT devices, mobile applications, video cameras, document readers, and other data collection or processing tools. The system may also outline any manual intervention points required within the workflow.

In some cases, users may have the ability to view suggested workflows through a graphical user interface or access workflow details programmatically via APIs. This flexibility may allow for integration with existing business systems and processes.

The platform may provide mechanisms for users to customize and influence the suggested workflows. Users may have the option to edit workflows by adding manual intervention steps or configuring criteria for when these steps should be executed. This customization capability may allow organizations to incorporate domain-specific knowledge and business rules into the AI-driven workflows.

After customization, the system may offer a validation process for the modified workflows. This validation may help ensure that the customized workflow remains compatible with the platform's capabilities and meets the organization's requirements.

Once a workflow is validated and approved, the platform may facilitate its implementation. The system may guide users through the process of adding required devices and connecting them to the platform. As users perform the necessary actions, the platform may correlate information across various data sources and execute the workflow as designed.

The workflow suggestion and implementation system may support a wide range of business use cases. For example, in a manufacturing context, the system may suggest workflows for validating raw material shipments, ensuring compliance with specifications, and automating invoice processing and payment procedures.

By providing this workflow suggestion and implementation capability, the unified platform may enable organizations to leverage AI technologies for complex business processes without requiring extensive expertise in AI development or system integration. This approach may help reduce the need for specialized solution consultants, AI practitioners, and IT personnel, potentially accelerating the deployment of AI solutions and reducing associated costs.

The unified platform may incorporate a system for efficient operations using auto-generated monitoring profiles. This system may be designed to optimize operational performance and reduce costs associated with managing AI deployments across distributed environments.

In some cases, the platform may automatically generate monitoring profiles for applications, platform components, and infrastructure elements. These profiles may be based on various data points collected by the system, including customer intent for deployed applications, application specifications, resource usage metrics, and infrastructure performance data.

The auto-generated monitoring profiles may define rules and thresholds for alerting operational users, application developers, or customers about potential issues or anomalies. By automatically generating these profiles, the system may reduce the manual effort required to set up and maintain monitoring configurations.

In some implementations, the platform may employ adaptive learning techniques to refine and adjust monitoring profiles over time. This adaptive approach may allow the system to improve the accuracy and relevance of monitoring alerts based on historical data and observed patterns.

The adaptive learning process may involve analyzing the effectiveness of existing monitoring rules and thresholds. For example, the system may evaluate the frequency and accuracy of alerts generated by each monitoring profile. Based on this analysis, the system may automatically adjust alert thresholds or modify monitoring rules to reduce false positives and improve overall alert quality.

In some cases, the platform may provide mechanisms for operational users, application developers, or customers to provide feedback on monitoring alerts through natural language inputs. This feedback may be used to further refine the monitoring profiles and tailor them to specific deployment scenarios or business requirements.

The system may also consider the cost implications of monitoring activities when generating and adjusting profiles. For example, the platform may analyze the operational costs associated with responding to different types of alerts and adjust monitoring thresholds accordingly to optimize resource utilization.

In some implementations, the auto-generated monitoring profiles may be tailored to specific application types or deployment environments. For instance, the system may generate different monitoring profiles for edge deployments compared to cloud-based deployments, taking into account the unique characteristics and constraints of each environment.

The platform may also provide visualization tools and dashboards to help users understand the performance of their AI deployments and the effectiveness of the auto-generated monitoring profiles. These tools may allow users to gain insights into resource utilization, application performance, and overall system health.

By implementing this system for efficient operations with auto-generated and adaptive monitoring profiles, the unified platform may help organizations reduce operational costs associated with managing AI deployments. The automated approach to monitoring may minimize the need for manual configuration and maintenance of monitoring systems, potentially freeing up IT resources for other value-adding activities.

Additionally, the adaptive nature of the monitoring profiles may lead to improved system performance over time. As the profiles become more accurate and tailored to specific deployment scenarios, organizations may experience fewer false alarms and more timely notifications of genuine issues, enabling proactive management of their AI infrastructure.

The unified platform for deploying and operating AI agents and applications across distributed environments may integrate various components to provide a comprehensive solution for organizations. These components may work together to enable seamless deployment, efficient data management, and optimized operations across diverse environments.

In some cases, the hub-and-spoke architecture illustrated in FIG. 1 may serve as the foundation for the platform's distributed capabilities. The AI Hub, acting as the central management location, may coordinate with multiple edge locations to facilitate distributed AI processing while maintaining centralized control. This architecture may allow for efficient distribution of AI processing tasks, with the AI Hub handling more complex operations and edge locations performing local processing and data collection.

The distributed data fabric architecture, as depicted in FIG. 3, may complement the hub-and-spoke model by enabling seamless data access and management across multiple trust zones and deployment locations. This data fabric may provide a virtual datastore or global namespace for data, allowing AI agents and applications to interact with data without needing to know its physical location. The data orchestration layer may facilitate communication across trust zones while maintaining security boundaries.

In some implementations, the data access control system illustrated in FIG. 4 may work in conjunction with the distributed data fabric to enforce enterprise controls for data serving and access. This system may utilize Access Control List (ACL) statements to manage and restrict data access, ensuring that AI agents operate within authorized boundaries. The Data Access Gateway and Authorizer components may work together to validate data access requests against defined ACL statements before granting access or forwarding requests to other data nodes.

The business SLA-driven agent orchestrator may leverage the safe context generated from user scope and regulatory requirements to optimize resource allocation and agent operations. This orchestrator may interact with the distributed data fabric and access control system to ensure that AI agents operate efficiently while adhering to security and compliance requirements.

The workflow suggestion and implementation system may utilize the platform's distributed architecture and data management capabilities to design and execute AI-driven workflows. This system may integrate various data sources and devices across the distributed environment, leveraging the platform's ability to correlate information from multiple sources.

The auto-generated monitoring profiles for efficient operations may collect data from various components across the distributed environment, including application metrics, resource usage, and infrastructure performance. These profiles may adapt over time based on observed patterns and feedback, potentially improving the overall efficiency of the AI deployments.

In some cases, the one-click move or similar simplified deployment feature, as illustrated in FIG. 5, may leverage the platform's distributed architecture and data management capabilities to facilitate seamless relocation of AI agents and applications between different deployment environments. This feature may interact with various components, such as the distributed data fabric and access control system, to ensure proper configuration and data access in the new deployment location.

By integrating these components, the unified platform may provide a cohesive solution for deploying and managing AI agents and applications across diverse environments. The synergies between different components may contribute to the system's effectiveness in addressing challenges related to deployment flexibility, data management, security, and operational efficiency.

The system and/or method as described above may provide an easy, one-time migration path for AI solution providers to migrate their current solution from any of the existing public cloud providers to a single platform, thereby enabling them to deploy their solutions to the customer's data center, and/or their VPC in their current cloud provider. The system and/or method may allow enterprises to have controls on where they want their data to be served, and who can access the data. The system and/or method may provide a business SLA-driven agent orchestrator, with an orchestration engine that understands the business requirements that need to be delivered by the AI agents and exploits that to optimize infrastructure resource usage. The system and/or method may provide access control for agents for security and compliance, to control which agents can talk to which other agent. The system and/or method may provide data control for agents to control what agent has access to what data, historical data usage, and easy way to grant/revoke access. The system and/or method may provide the ability to suggest workflows (on-demand or pre-validated ones from a catalog) for business problems, which include IOT devices, Mobile Apps, Video Camera's, Document Readers, etc. and ability to correlate and tie back the real data from those sources back to the business workflow. The system and/or method may provide mechanisms for users to influence the workflow or add human intervention points in the middle of AI workflows. The system and/or method may provide efficient operations using auto-generated monitoring profiles for application, platform and infrastructure, to provide adaptive learning and adjusting of the monitoring profile for low noise operational engagement and reduced operational cost.

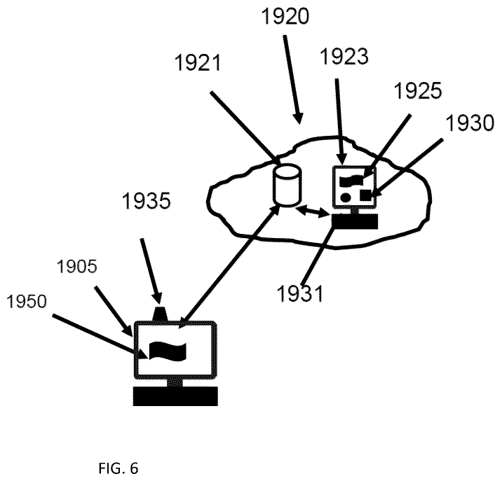

FIG. 6 depicts the system architecture, showing the cloud storage interface and cloud network. As shown in FIG. 6 the cloud storage interface and cloud network 1920, which connects to a data storage system 1921. The cloud network 1120 runs a control program 1925 on cloud computer 1923 that interfaces with the data storage system 1921. The GPS module 1935 is used by the user device 1905 and it communicates with the access control program 1950 which will only allow access to the cloud storage interface and cloud network 1920 if the GPS information transmitted from the user device 1905 is contained in a sanctioned GPS location list 1930 or if the IP address of the user device 1905 is in a sanctioned IP address list 1931.

The instant invention addresses the problem of Cloud Vulnerabilities and Mobile Device Vulnerabilities. By creating a system that allows access to the systems while ensuring that the devices interacting with the system are sanctioned and allowed to use the system. The instant invention has two methods it can employ to solve the authorized connection problem which is at the heart of any Cloud Vulnerabilities and Mobile Device Vulnerabilities issues. It can use a Global Positioning System (GPS) location filter or an Internet Protocol (IP) address (IP address) filter that allows only those devices that either are from the correct or allowed GPS locations or have the correct IP address. The system can use these filters either individually or in combination to limit access to the system. The system use of these security measures results in a system that can only be implemented with a dedicated network of computerized devices. That network comprises of a cloud server or equivalent system and remote sanctioned smart devices that have either a validated IP address or are located in a sanctioned location that is verified by the GPS location.

Another way of ensuring security is to put the user application on a dedicated device that is limited to using only the system of the current disclosure. This prevents access by users without the sanctioned system. The sanctioned devices could be limited by their Internet protocol (IP) address and the system checks the IP address to ensure it is in the sanctioned device file on the system and if the IP address is in the sanctioned device file then the system allows access to the cloud system. This protects the data stored on the cloud system from being maliciously tampered with.

In some embodiments the method or methods described above may be executed or carried out by a computing system including a tangible computer-readable storage medium, also described herein as a storage machine, that holds machine-readable instructions executable by a logic machine (i.e. a processor or programmable control device) to provide, implement, perform, and/or enact the above described methods, processes and/or tasks. When such methods and processes are implemented, the state of the storage machine may be changed to hold different data. For example, the storage machine may include memory devices such as various hard disk drives, CD, or DVD devices. The logic machine may execute machine-readable instructions via one or more physical information and/or logic processing devices. For example, the logic machine may be configured to execute instructions to perform tasks for a computer program. The logic machine may include one or more processors to execute the machine-readable instructions. The computing system may include a display subsystem to display a graphical user interface (GUI) or any visual element of the methods or processes described above. For example, the display subsystem, storage machine, and logic machine may be integrated such that the above method may be executed while visual elements of the disclosed system and/or method are displayed on a display screen for user consumption. The computing system may include an input subsystem that receives user input. The input subsystem may be configured to connect to and receive input from devices such as a mouse, keyboard or gaming controller. For example, a user input may indicate a request that certain task is to be executed by the computing system, such as requesting the computing system to display any of the above described information, or requesting that the user input updates or modifies existing stored information for processing. A communication subsystem may allow the methods described above to be executed or provided over a computer network. For example, the communication subsystem may be configured to enable the computing system to communicate with a plurality of personal computing devices. The communication subsystem may include wired and/or wireless communication devices to facilitate networked communication. The described methods or processes may be executed, provided, or implemented for a user or one or more computing devices via a computer-program product such as via an application programming interface (API).

Since many modifications, variations, and changes in detail can be made to the described embodiments of the invention, it is intended that all matters in the foregoing description and shown in the accompanying drawings be interpreted as illustrative and not in a limiting sense. Furthermore, it is understood that any of the features presented in the embodiments may be integrated into any of the other embodiments unless explicitly stated otherwise. The scope of the invention should be determined by the appended claims and their legal equivalents.

In addition, the present invention has been described with reference to embodiments; it should be noted and understood that various modifications and variations can be crafted by those skilled in the art without departing from the scope and spirit of the invention. Accordingly, the foregoing disclosure should be interpreted as illustrative only and is not to be interpreted in a limiting sense. Further it is intended that any other embodiments of the present invention that result from any changes in application or method of use or operation, method of manufacture, shape, size, or materials which are not specified within the detailed written description or illustrations contained herein are considered within the scope of the present invention.

Insofar as the description above and the accompanying drawings disclose any additional subject matter that is not within the scope of the claims below, the inventions are not dedicated to the public and the right to file one or more applications to claim such additional inventions is reserved.

Although very narrow claims are presented herein, it should be recognized that the scope of this invention is much broader than presented by the claim. It is intended that broader claims will be submitted in an application that claims the benefit of priority from this application.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

I claim:

1. A system, comprising:
a central management location configured to coordinate AI deployments;
a plurality of edge locations connected to the central management location, each edge location configured to host AI agents;
a distributed data fabric spanning the central management location and the edge locations, the distributed data fabric providing location-agnostic data access for the AI agents; and
an orchestrator configured to manage deployment and operation of the AI agents based on business requirements associated with the edge locations.

2. The system of claim 1, wherein the distributed data fabric comprises a plurality of trust zones, each trust zone containing one or more data nodes.

3. The system of claim 2, wherein each data node comprises a data access gateway configured to authorize data access requests from the AI agents.

4. The system of claim 3, wherein the data access gateway utilizes Access Control List statements to manage and restrict data access, the Access Control List statements comprising:
a Subject attribute identifying an entity requesting access;
a Role attribute defining a set of permissions associated with the Subject; and
a Scope attribute specifying a data resource to which the permissions apply.

5. The system of claim 1, wherein the orchestrator is configured to generate a safe context for each AI agent based on user scope and regulatory requirements, the safe context defining boundaries within which the AI agent is authorized to operate.

6. The system of claim 5, wherein the user scope comprises a role-based access control scope indicating a role of a user in the system.

7. The system of claim 5, wherein the orchestrator is configured to dynamically adjust resource allocation for the AI agents based on the safe context and real-time performance data.

8. The system of claim 1, wherein the central management location comprises:
an AI apps database configured to store application data and configurations;
AI foundational services comprising large language model based agent deployment capabilities; and
AI core infrastructure services comprising a data fabric service and GPU management services.

9. The system of claim 1, wherein each edge location comprises:
a device controller configured to interface with input and output devices including audio devices, video devices, and IoT devices; and
minimal infrastructure services configured to support AI agent execution at the edge location.

10. The system of claim 1, further comprising a cloud console configured to establish a secure connection to the central management location, the cloud console providing infrastructure lifecycle management and application lifecycle management for the central management location and the plurality of edge locations.

11. A method, comprising:
receiving a request to deploy an AI agent;
determining a deployment location from a plurality of available locations including edge locations and cloud environments;
generating a deployment workflow for the AI agent based on the determined deployment location;
validating the deployment workflow; and
subject to successful validation, executing the validated deployment workflow to deploy the AI agent at the determined deployment location.

12. The method of claim 11, further comprising generating a safe context for the AI agent based on user scope and regulatory requirements, the safe context defining boundaries within which the AI agent is authorized to operate.

13. The method of claim 12, further comprising configuring the AI agent to operate within the boundaries defined by the safe context, wherein the safe context includes permissions for accessing specific datasets within a distributed data fabric.

14. The method of claim 13, wherein the distributed data fabric spans multiple trust zones, each trust zone containing one or more data nodes, the method further comprising:
receiving a data access request from the deployed AI agent;
routing the data access request through a data access gateway; and
authorizing the data access request based on Access Control List statements associated with the AI agent.

15. The method of claim 14, wherein authorizing the data access request comprises:
verifying that the requested data access falls within the boundaries defined by the safe context; and
granting access only if the verification is successful.

16. The method of claim 11, wherein validating the deployment workflow comprises:
verifying whether data controls are enabled for the AI agent to operate at the determined deployment location; and
verifying whether appropriate resources exist at the determined deployment location to support execution of the AI agent.

17. A non-transitory computer-readable medium storing instructions that, when executed by a processor, cause the processor to perform operations comprising:
receiving a data access request from an AI agent deployed across a distributed environment;
determining a safe context for the AI agent based on user scope and regulatory requirements, the safe context defining boundaries within which the AI agent is authorized to operate;
validating the data access request against access control rules within the determined safe context; and
subject to successful validation, providing the AI agent with access to requested data through a distributed data fabric spanning multiple deployment locations.

18. The non-transitory computer-readable medium of claim 17, wherein the distributed data fabric comprises a plurality of trust zones, each trust zone containing one or more data nodes, and wherein each data node comprises a data access gateway configured to authorize data access requests from the AI agent.

19. The non-transitory computer-readable medium of claim 18, wherein validating the data access request comprises verifying that the requested data access falls within the boundaries defined by the safe context and granting access only if the verification is successful.

20. The non-transitory computer-readable medium of claim 17, wherein the operations further comprise:
monitoring performance metrics of the AI agent;
dynamically adjusting resource allocation for the AI agent based on the monitored performance metrics and the safe context; and
generating a deployment workflow for the AI agent based on a determined deployment location.
